(19) United States
(12) Patent Application Publication
(10) Pub. No.: US 2026/0019014 A1
(43) Pub. Date: Jan. 15, 2026

(54) Motor Control Apparatus and Motor Control Method

(71) Applicant: Hitachi Astemo, Ltd., Hitachinaka-shi, Ibaraki (JP)

(72) Inventors: Hiroto SAOTOME, Hitachinaka-shi, Ibaraki (JP); Masaki HANO, Hitachinaka-shi, Ibaraki (JP)

(21) Appl. No.: 19/112,035

(22) PCT Filed: Sep. 7, 2023
(86) PCT No.: PCT/JP2023/032664

§ 371 Date: Mar. 14, 2025

(30) Foreign Application Priority Data
Sep. 22, 2022 (JP) 2022-151684

(51) Int. Cl. H02P 6/30; H02P 6/185

(52) U.S. Cl. CPC H02P 6/30; H02P 6/185; H02P 2207/05

(57) ABSTRACT

The rotor of an electric motor is rotated by sequentially switching the energization mode that determines two phases to which a pulse voltage is applied, among the three phases of the electric motor. The pulse voltage alternately generates a first pulse that rotates the rotor in one direction and a second pulse that has a polarity opposite to that of the first pulse and that rotates the rotor in the opposite direction. The energization mode is sequentially switched to the one direction or the opposite direction, based on the comparison between a value of a first open-phase voltage induced by application of the first pulse and a first threshold. The first threshold is set based on a value of the first open-phase voltage and a first initial threshold that is set in advance per energization mode.

### TECHNICAL FIELD

The present invention relates to a motor control apparatus and a motor control method.

### BACKGROUND ART

There is known motor control that rotates the rotor of an electric motor by sequentially switching the energization mode that determines two-phase coils to which a pulse voltage is applied, among the three-phase coils of the electric motor (for example, see Patent Document 1). This pulse voltage alternately generates a forward pulse that rotates the rotor in a forward direction and generates a reverse pulse that has the polarity opposite to that of the forward pulse and that rotates the rotor in a reverse direction. By inverting the comparative relationship between the forward pulse application time and the reverse pulse application time, whether the rotor is rotated in the forward direction or reverse direction is controlled. In addition, when a forward open-phase voltage that is induced in an open phase by application of the forward pulse crosses a forward threshold that is set per energization mode in a predetermined direction, the energization mode is switched to the forward direction. On the other hand, when a reverse open-phase voltage that is induced in an open phase by application of the reverse pulse crosses a reverse threshold that is set per energization mode in a predetermined direction, the energization mode is switched to the reverse direction.

### REFERENCE DOCUMENT LIST

### Patent Document

Patent Document 1: International Republication No. WO2012/029451

### SUMMARY OF THE INVENTION

### Problem to be Solved by the Invention

When the rotation of the rotor is switched from the forward direction to the reverse direction, more specifically, immediately after the recent switching of the energization mode when the rotation of the rotor has not yet been changed from the forward rotation to the reverse rotation, there are cases in which the value of the reverse open-phase voltage has already crossed the reverse threshold in the predetermined direction. If this happens, unless the reverse open-phase voltage changes back to a value prior to the crossing of the reverse threshold in the predetermined direction before the rotation of the rotor changes from the forward rotation to the reverse rotation, even if the rotor begins its reverse rotation, the reverse open-phase voltage cannot cross the reverse threshold in the predetermined direction. As a result, a loss of synchronization occurs. Of course, this loss of synchronization may also occur when forward drive is started from the reverse state of the rotor.

In addition, the reverse open-phase voltage and the forward open-phase voltage immediately after switching of the energization mode vary due to various factors such as individual variability among electric motors. Therefore, it is difficult to set the reverse threshold and the forward threshold to certain values in advance, in order to avoid the loss of synchronization associated with the inversion of the rotation direction.

The present invention has been made in view of the above-described problem, and an object of the present invention is to provide a motor control apparatus and a motor control method that reduces occurrence of a loss of synchronization in an electric motor.

### Means for Solving the Problem

Thus, a motor control apparatus and a motor control method according to the present invention enable rotation of the rotor of an electric motor by sequentially switching the energization mode that determines two-phase coils to which a pulse voltage is applied, among the three-phase coils of the electric motor. A control signal is output to a drive circuit that drives the electric motor such that the pulse voltage alternately generates a first pulse that rotates the rotor in one direction and a second pulse that has a polarity opposite to that of the first pulse and that rotates the rotor in a direction opposite to the one direction. Rotation drive is controlled in the one direction or the opposite direction by inverting the comparative relationship between the application time of the first pulse and the application time of the second pulse. A first open-phase voltage induced in an open phase when the first pulse is applied is detected, and a second open-phase voltage induced in an open phase when the second pulse is applied is detected. A first threshold that defines a value of the first open-phase voltage when the energization mode is switched to the one direction is set per energization mode, and a second threshold that defines a value of the second open-phase voltage when the energization mode is switched to the opposite direction is set per energization mode. The energization mode is switched to the one direction or the opposite direction, based on the result of the comparison between a value of the first open-phase voltage and the first threshold and based on the result of the comparison between a value of the second open-phase voltage and the second threshold. When the energization mode is switched to the opposite direction, the first threshold is set based on a first switching time detection value, which is a value of the first open-phase voltage immediately after the switching of the energization mode, and based on a first initial threshold that is set in advance per energization mode. When the energization mode is switched to the one direction, the second threshold is set based on a second switching time detection value, which is a value of the second open-phase voltage immediately after the switching of the energization mode, and based on a second initial threshold that is set in advance per energization mode.

### Effects of the Invention

A motor control apparatus according to the present invention is able to reduce occurrence of a loss of synchronization in an electric motor.

### BRIEF DESCRIPTION OF THE DRAWINGS

FIG. 1 is a schematic configuration diagram illustrating an example of an electric motor and a drive control system therefor.

FIG. 2 is a schematic configuration diagram illustrating an example of the hardware configuration of a motor control apparatus.

FIG. 3 is a diagram schematically illustrating an example of square-wave drive executed when the rotor is rotated in the forward direction.

FIG. 4 is a diagram schematically illustrating an example of square-wave drive executed when the rotor is rotated in the reverse direction.

FIG. 5 is a diagram schematically illustrating open-phase voltages in energization mode [3].

FIG. 6 is a diagram schematically illustrating change of a forward open-phase voltage with respect to the rotor rotation angle.

FIG. 7 is a diagram schematically illustrating change of a reverse open-phase voltage with respect to the rotor rotation angle.

FIG. 8 is a functional block diagram relating to low-speed sensorless control of the motor control apparatus.

FIG. 9 is a functional block diagram illustrating a detailed configuration of a voltage command adjustment unit.

FIG. 10 is a functional block diagram illustrating a detailed configuration of a control signal generation unit.

FIG. 11 is a time chart illustrating control signal waveforms when an application voltage command value is zero.

FIG. 12 is a time chart illustrating the control signal waveforms when the application voltage command value is a positive value.

FIG. 13 is a time chart illustrating the control signal waveforms when the application voltage command value is a negative value.

FIG. 14 is a functional block diagram illustrating a detailed configuration of an open-phase voltage detection unit.

FIG. 15 is a functional block diagram illustrating a detailed configuration of a forward threshold setting unit.

FIG. 16 is a functional block diagram illustrating a detailed configuration of a reverse threshold setting unit.

FIG. 17 is a time chart illustrating an improved operation example of the electric motor.

FIG. 18 is a diagram illustrating change of open-phase voltages in FIG. 17 with respect to the rotor rotation angle.

FIG. 19 is a diagram illustrating lower limit values of thresholds that are set in energization mode [3].

FIG. 20 is a diagram illustrating upper limit values of thresholds that are set in energization mode [4].

FIG. 21 is a time chart illustrating a conventional operation example of the electric motor.

FIG. 22 is a diagram illustrating change of open-phase voltages in FIG. 21 with respect to the rotor rotation angle.

### MODE FOR CARRYING OUT THE INVENTION

Hereinafter, an example for carrying out the present invention will be described in detail with reference to the attached drawings.

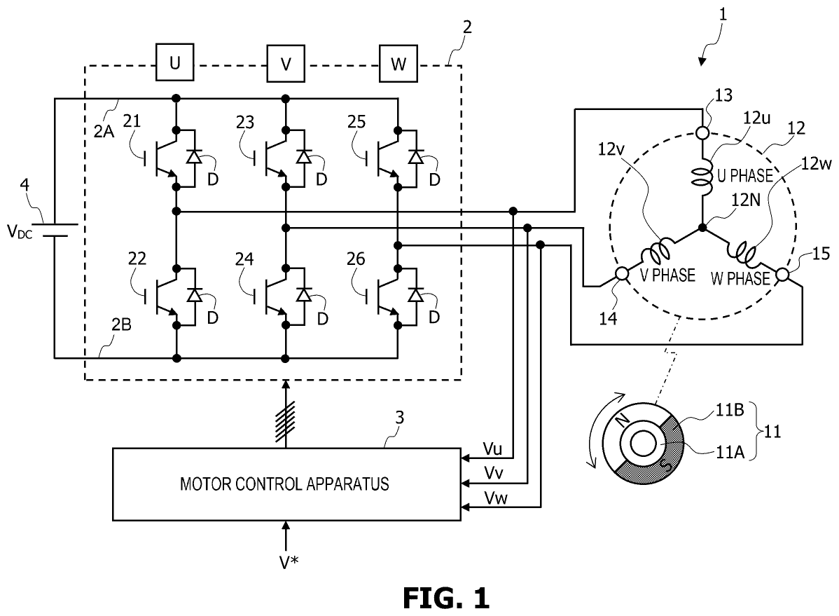

FIG. 1 illustrates an example of an electric motor and a drive control system therefor.

An electric motor 1 is driven by a drive circuit 2. Drive circuit 2 is controlled by a motor control apparatus 3, and driving of electric motor 1 is consequently controlled. Motor control apparatus 3 can control electric motor 1 so that electric motor 1 rotates in two directions of the forward direction and the reverse direction. Electric motor 1 capable of rotating in these two directions is used as a power source for various in-vehicle devices. For example, electric motor 1 is used as a power source capable of rotating in the two directions of the forward direction and the reverse direction, for adjusting the top dead center position of a piston in a variable compression mechanism of an internal combustion engine. Electric motor 1 can also be applied to a power source capable of rotating in the two directions of the forward direction and the reverse direction, for an electric water pump for circulating engine coolant, for an electronically controlled throttle for adjusting the intake air volume in an internal combustion engine, for an electric parking brake, etc.

### Schematic Configuration of Electric Motor

Electric motor 1 is a three-phase synchronous motor, and includes: a rotor 11 having permanent magnets 11B of different polarities that are alternately disposed in the rotation direction around a rotor yoke 11A; and a stator 12 provided with a U-phase coil 12u, a V-phase coil 12v, and a W-phase coil 12w. Stator 12 includes teeth (not illustrated) facing rotor 11 in a radial direction perpendicular to the rotation shaft of rotor 11. These teeth are sequentially arranged in the rotation direction of rotor 11, and are connected by a stator yoke. Three-phase coils 12u, 12v, and 12w are wound around these teeth of stator 12. One end of each of three-phase coils 12u, 12v, and 12w is Y-connected, so as to form a neutral point 12N.

### Schematic Configuration of Drive Circuit

Drive circuit 2 receives a direct-current (DC) voltage V_{DC} from an in-vehicle battery 4, and includes a three-phase bridge circuit in which a U-phase arm, a V-phase arm, and a W-phase arm are connected in parallel between a positive-side bus bar 2A connected to the positive terminal of in-vehicle battery 4 and a negative-side bus bar 2B connected to the negative terminal of in-vehicle battery 4. The U-phase arm is constituted by an upper-arm switching element 21 and a lower-arm switching element 22, which are connected in series, and the other end 13 of U-phase coil 12u is connected to a node on the path between these two switching elements 21 and 22. The V-phase arm is constituted by an upper-arm switching element 23 and a lower-arm switching element 24, which are connected in series, and the other end 14 of V-phase coil 12v is connected to a node on the path between these two switching elements 23 and 24. The W-phase arm is constituted by an upper-arm switching element 25 and a lower-arm switching element 26, which are connected in series, and the other end 15 of W-phase coil 12w is connected to a node on the path between these two switching elements 25 and 26.

In drive circuit 2, each of switching elements 21 to 26 has an anti-parallel freewheeling diode D and an externally controllable control electrode, and executes a switching operation for switching between the ON state and OFF state in accordance with a control signal that is input to its control electrode. For example, power semiconductor elements such as metal-oxide-semiconductor field-effect transistors (MOSFETs) or insulated gate bipolar transistors (IGBTs) are used as switching elements 21 to 26. The following description assumes that N-channel MOSFETs are used as switching elements 21 to 26. When any one of switching elements 21 to 26 is set to the ON state by a high level gate signal, which is equal to or greater than a threshold voltage, its drain and source are electrically connected to each other. When this switching element is set to the OFF state by a low-level gate signal, which is less than the threshold, the electrical connection between the drain and the source is disconnected.

### Overview of Motor Control Apparatus

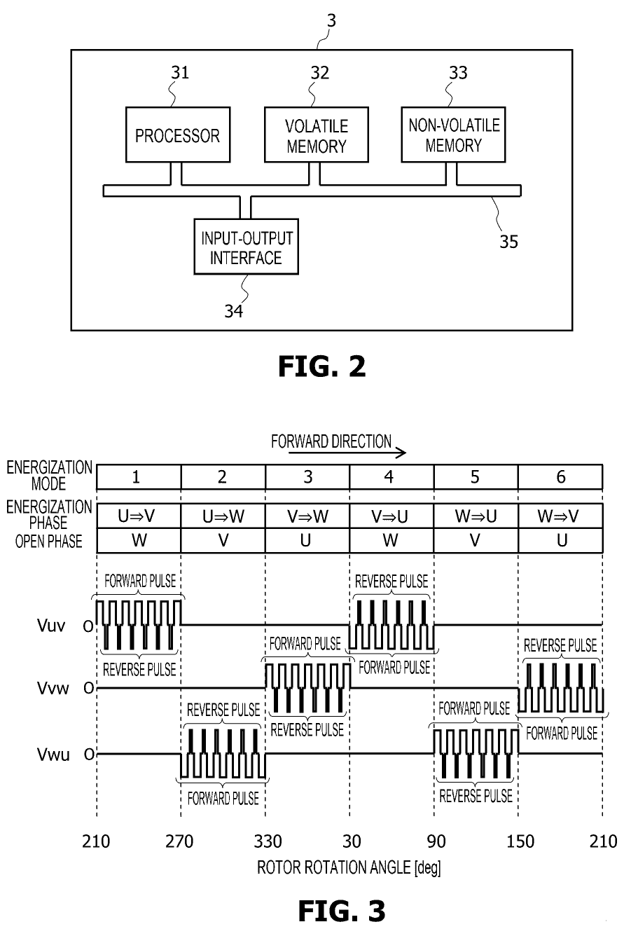

Motor control apparatus 3 includes a computer, and FIG. 2 illustrates a hardware configuration example of the computer. Specifically, motor control apparatus 3 includes a processor 31 such as a central processing unit (CPU) that executes arithmetic control. In addition, motor control apparatus 3 includes a volatile memory 32 such as a static random access memory (SRAM) or a dynamic random access memory (DRAM) that temporarily stores information. Motor control apparatus 3 also includes a non-volatile memory 33 such as a flash memory that permanently stores information. Motor control apparatus 3 also includes an input-output interface 34 that exchanges signals with external elements. These devices are connected to each other by a bus 35 such that the devices can communicate with each other.

Referring back to FIG. 1, motor control apparatus 3 receives a command signal including an application voltage command value V*, and also receives three-phase application voltages Vu, Vv, and Vw. Based on the signal and voltages, motor control apparatus 3 generates and outputs a gate signal for each of switching elements 21 to 26. Herein, application voltage command value V* is calculated by a higher-level control apparatus than motor control apparatus 3, and represents zero, a positive value, or a negative value. Application voltage command value V* representing a positive value indicates a forward drive command for rotating electric motor 1 in the forward direction. Application voltage command value V* representing a negative value indicates a reverse drive command for rotating electric motor 1 in the reverse direction. Application voltage command value V* representing zero indicates a drive stop command for stopping electric motor 1. In addition, regarding three-phase application voltages Vu, Vv, and Vw, U-phase application voltage Vu corresponds to the voltage of the other end 13 of U-phase coil 12u, V-phase application voltage Vv corresponds to the voltage of the other end 14 of V-phase coil 12v, and W-phase application voltage Vw corresponds to the voltage of the other end 15 of W-phase coil 12w. If motor control apparatus 3 is capable of detecting the operation or state of a system that uses electric motor 1 as a power source, motor control apparatus 3 may calculate application voltage command value V* such that this system is set to its target operation or state. In addition, the gate signals may be output via a pre-driver that adjusts the voltages of the gate signals to voltages suitable for the driving of switching elements 21 to 26.

Motor control apparatus 3 uses sine-wave drive (180° energization) in a high rotation speed range, which is equal to or greater than a predetermined rotation speed, and uses square-wave drive (120° energization) in a low rotation speed range, which is less than the predetermined rotation speed, as methods for driving electric motor 1. The sine-wave drive is a method in which electric motor 1 is driven by adding a pseudo-sine wave voltage to three-phase coils 12u, 12v, and 12w. On the other hand, the square-wave drive is a method in which electric motor 1 is driven by sequentially switching the energization mode that determines two-phase coils to which a pulse voltage is applied, among three-phase coils 12u, 12v, and 12w, for every 60° of electrical angle.

From the viewpoint of reduction in the cost and the size of products, motor control apparatus 3 controls the driving of electric motor 1 based on sensorless control that estimates the rotation angle of rotor 11 (hereinafter referred to as “rotor rotation angle”), without using a position detection sensor such as a Hall sensor. In the sensorless control in the sine-wave drive, motor control apparatus 3 detects the rotor rotation angle based on an induced voltage (back electromotive force) that is generated as rotor 11 rotates. On the other hand, in the sensorless control in the square-wave drive, motor control apparatus 3 detects the switching timing of the energization mode, based on the comparison between the value of the pulse-induced voltage (hereinafter referred to as “open-phase voltage”) that is generated in the non-energized open-phase coil by application of a pulse voltage to the two-phase coils and a predetermined threshold. This is because it may be difficult to accurately detect the back electromotive force when the rotation speed is less than the predetermined rotation speed.

If use of motor control apparatus 3 is not assumed to be in the high rotation speed range in a system using electric motor 1 as a power source, electric motor 1 may be driven only by the square-wave drive. Hereinafter, description relating to the control of the sine-wave drive will be omitted. Description will now be given for the control of the square-wave drive (low-speed sensorless control) that detects the switching timing of the energization mode based on the value of the open-phase voltage and the predetermined threshold.

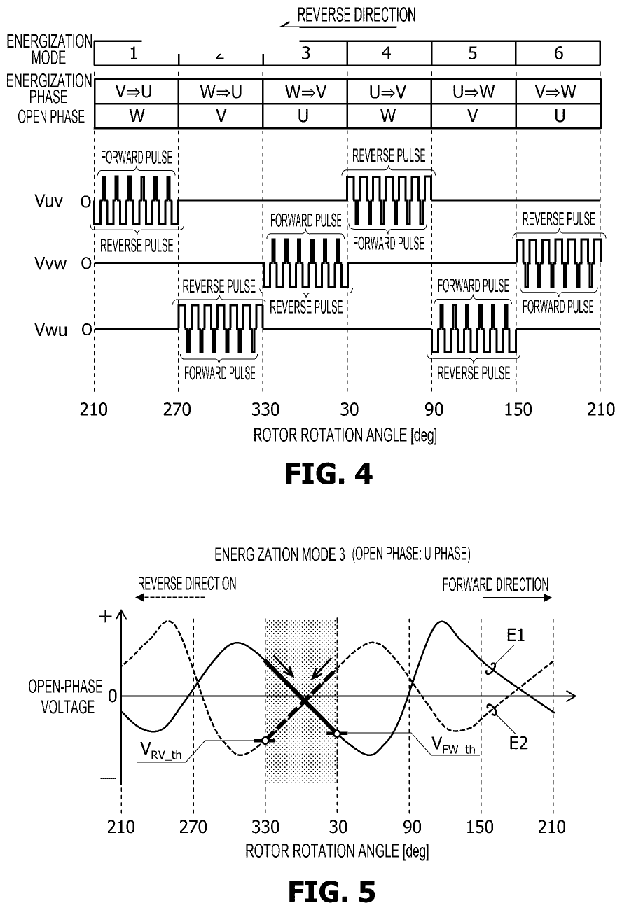

Next, the square-wave drive of electric motor 1 will be described with reference to FIGS. 3 and 4. FIG. 3 illustrates an example of the square-wave drive executed when rotor 11 is rotated in the forward direction, and FIG. 4 illustrates an example of the square-wave drive executed when rotor 11 is rotated in the reverse direction. Six energization modes [1] to [6] are used by the square-wave drive.

As illustrated in FIG. 3, when rotor 11 is rotated in the forward direction, energization modes [1] to [6] are sequentially switched, in this order. On the other hand, as illustrated in FIG. 4, when rotor 11 is rotated in the reverse direction, energization modes [1] to [6] are sequentially switched in the reverse order.

In any one of energization modes [1] to [6], when the rotor rotation angle matches a corresponding predetermined angle (energization switching angle), this energization mode is switched. The energization switching angles are set at intervals of 60° of electrical angle, and are associated with energization modes [1] to [6]. For example, six angles of 210°, 270°, 330°, 30°, 90°, and 150° are set as the energization switching angles. In this setting, when rotor 11 is rotated in the forward direction, if the rotor rotation angle reaches 210°, the current energization mode is switched to energization mode [1]. If the rotor rotation angle reaches 270°, the current energization mode is switched to energization mode [2]. If the rotor rotation angle reaches 330°, the current energization mode is switched to energization mode [3]. If the rotor rotation angle reaches 30°, the current energization mode is switched to energization mode [4]. If the rotor rotation angle reaches 90°, the current energization mode is switched to energization mode [5]. If the rotor rotation angle reaches 150°, the current energization mode is switched to energization mode [6]. When rotor 11 is rotated in the reverse direction, if the rotor rotation angle reaches 210°, the current energization mode is switched to energization mode [6]. If the rotor rotation angle reaches 150°, the current energization mode is switched to energization mode [5]. If the rotor rotation angle reaches 90°, the current energization mode is switched to energization mode [4]. If the rotor rotation angle reaches 30°, the current energization mode is switched to energization mode [3]. If the rotor rotation angle reaches 330°, the current energization mode is switched to energization mode [2]. If the rotor rotation angle reaches 270°, the current energization mode is switched to energization mode [1].

In FIGS. 3 and 4, the pulse voltages applied to the two-phase coils in energization modes [1] to [6] are indicated as a line-to-line voltage Vuv between the U phase and the V phase, a line-to-line voltage Vvw between the V phase and the W phase, and a line-to-line voltage Vwu between the W phase and the U phase. Herein, line-to-line voltage Vuv is the difference [Vu−Vv] obtained by subtracting V-phase application voltage Vv from U-phase application voltage Vu, line-to-line voltage Vvw is the difference [Vv−Vw] obtained by subtracting W-phase application voltage Vw from V-phase application voltage Vv, and line-to-line voltage Vwu is the difference [Vw−Vu] obtained by subtracting U-phase application voltage Vu from W-phase application voltage Vw.

In FIGS. 3 and 4, each of line-to-line voltages Vuv, Vvw, and Vwu includes a forward pulse (first pulse) that causes a line-to-line current for rotating rotor 11 to flow in the forward direction, and includes a reverse pulse (second pulse) that has the polarity opposite to that of the forward pulse and that causes a line-to-line current for rotating rotor 11 to flow in the reverse direction. Line-to-line voltages Vuv, Vvw, and Vwu alternately generate a forward pulse and a reverse pulse.

As illustrated in FIG. 3, when rotor 11 is rotated in the forward direction, the pulse width of the individual forward pulse is greater than the pulse width of the individual reverse pulse in energization modes [1] to [6]. The difference between the two pulse widths represents a minimum value (for example, zero) when application voltage command value V* is zero, and expands as application voltage command value V* increases in the positive direction. In the case of line-to-line voltage Vuv in energization mode [1], the forward pulse is a pulse (positive pulse) having a positive value as its amplitude corresponding to DC voltage V_{DC}, so as to cause a line-to-line current to flow from the U phase to the V phase. On the other hand, in the case of line-to-line voltage Vwu in energization mode [2], the forward pulse is a pulse (negative pulse) having a negative value as its amplitude of which the absolute value corresponds to DC voltage V_{DC}, so as to cause a line-to-line current to flow from the U phase to the W phase. Similarly, in the case of line-to-line voltage Vvw in energization mode [3], the forward pulse is a positive pulse, so as to cause a line-to-line current to flow from the V phase to the W phase. In the case of line-to-line voltage Vuv in energization mode [4], the forward pulse is a negative pulse, so as to cause a line-to-line current to flow from the V phase to the U phase. In addition, in a case of line-to-line voltage Vwu in energization mode [5], the forward pulse is a positive pulse, so as to cause a line-to-line current to flow from the W phase to the U phase. In the case of line-to-line voltage Vvw in energization mode [6], the forward pulse is a negative pulse, so as to cause a line-to-line current to flow from the W phase to the V phase. In energization modes [1] to [6], the individual reverse pulse is a positive pulse or a negative pulse having the polarity opposite to that of the corresponding forward pulse.

As illustrated in FIG. 4, when rotor 11 is rotated in the reverse direction, the pulse width of the individual reverse pulse is greater than the pulse width of the individual forward pulse in energization modes [1] to [6]. The difference between the two pulse widths represents a minimum value (for example, zero) when application voltage command value V* is zero, and expands as application voltage command value V* decreases in the negative direction. In addition, when rotor 11 is rotated in the reverse direction, the direction of the line-to-line current in energization modes [1] to [6] is opposite to that illustrated in FIG. 3. Thus, in the case of line-to-line voltage Vuv in energization mode [1], the reverse pulse is a negative pulse, so as to cause a line-to-line current to flow from the V phase to the U phase. In the case of line-to-line voltage Vwu in energization mode [2], the forward pulse is a positive pulse, so as to cause a line-to-line current to flow from the W phase to the U phase. Similarly, in the case of line-to-line voltage Vvw in energization mode [3], the reverse pulse is a negative pulse, so as to cause a line-to-line current to flow from the W phase to the V phase. In the case of line-to-line voltage Vuv in energization mode [4], the reverse pulse is a positive pulse, so as to cause a line-to-line current to flow from the U phase to the V phase. In addition, in the case of line-to-line voltage Vwu in energization mode [5], the reverse pulse is a negative pulse, so as to cause a line-to-line current to flow from the U phase to the W phase. In the case of line-to-line voltage Vvw in energization mode [6], the reverse pulse is a positive pulse, so as to a line-to-line current to flow from the V phase to the W phase. In energization modes [1] to [6], the individual reverse pulse is a positive pulse or a negative pulse having a polarity opposite to that of the corresponding forward pulse.

In energization mode [1] and energization mode [4], regardless of whether rotor 11 is rotated in the forward or reverse direction, a pulse voltage is applied to the U phase and the V phase, and therefore, an open-phase voltage is generated in the W phase, which is the non-energized open phase. In energization mode [2] and energization mode [5], regardless of whether rotor 11 is rotated in the forward or reverse direction, a pulse voltage is applied to the U phase and the W phase, and therefore, an open-phase voltage is generated in the V phase, which is the non-energized open phase. In energization mode [3] and energization mode [6], regardless of whether rotor 11 is rotated in the forward or reverse direction, a pulse voltage is applied to the V phase and the W phase, and therefore, an open-phase voltage is generated in the U phase, which is the non-energized open phase.

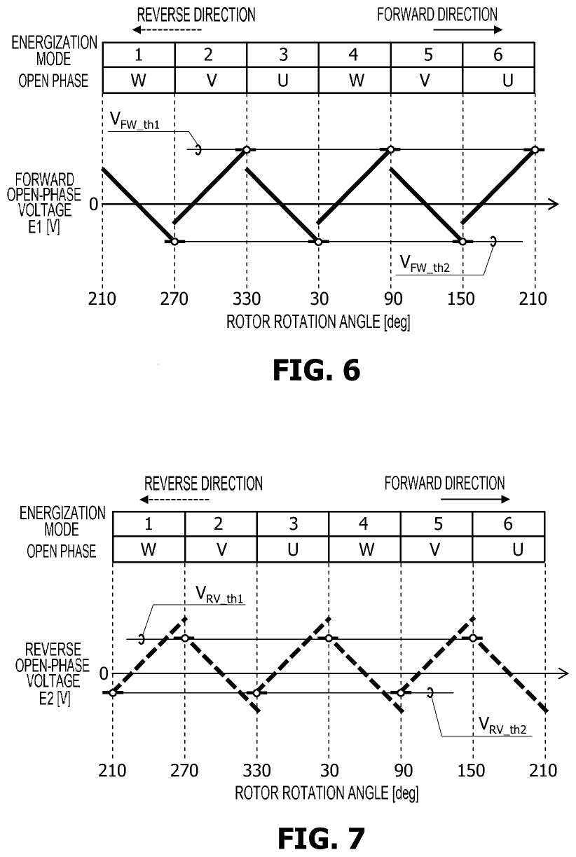

Next, a method of detecting the switching timing of the energization mode during the square-wave drive of electric motor 1 will be described with reference to FIGS. 5 to 7. FIG. 5 illustrates an example of change of the open-phase voltage induced by application of a forward pulse in energization mode [3] with respect to the rotor rotation angle, and illustrates an example of change of the open-phase voltage induced by application of a reverse pulse in energization mode [3] with respect to the rotor rotation angle. FIG. 6 illustrates the open-phase voltage generated by application of a forward pulse in the individual energization mode. FIG. 7 illustrates the open-phase voltage generated by application of a reverse pulse in the individual energization mode. The open-phase voltage in the individual energization mode is a relative value based on the potential of neutral point 12N and the value of the application voltage Vu, Vv, or Vw in the open phase, and may represent a positive or negative value. The potential of neutral point 12N may be set to half of DC voltage V_{DC}.

As illustrated in FIG. 5, in energization mode [3], a pulse voltage is applied to the V phase and the W phase, and the U phase is the open phase. The forward pulse is a positive pulse, and the reverse pulse is a negative pulse. Thus, an open-phase voltage E1 (hereinafter referred to as “forward open-phase voltage”), which is induced by application of the forward pulse, and an open-phase voltage E2 (hereinafter referred to as “reverse open-phase voltage”), which is induced by application of the reverse pulse, change differently with respect to the rotor rotation angle. Energization mode [3] is set in the range from 330° to 30° (shaded area in FIG. 5) in which forward open-phase voltage E1 monotonically decreases in the forward direction, and reverse open-phase voltage E2 monotonically decreases in the reverse direction. Thus, when forward open-phase voltage E1 falls below a forward threshold (first threshold) V_{FW_th}, which defines the value of forward open-phase voltage E1 at an energization switching angle of 30° in the forward direction, the switching timing from energization mode [3] to energization mode [4] is detected. In addition, when reverse open-phase voltage E2 falls below a reverse threshold (second threshold) V_{RV_th}, which defines the value of reverse open-phase voltage E2 at an energization switching angle of 330° in the reverse direction, the switching timing from energization mode [3] to energization mode [2] is detected.

In the present specification, the expression “when the value of forward open-phase voltage E1 falls below a forward threshold V_{FW_th}” means when the value of forward open-phase voltage E1 decreases from a value that is equal to or greater than forward threshold V_{FW_th} to a value that is less than forward threshold V_{FW_th}. In addition, the expression “when the value of forward open-phase voltage E1 exceeds forward threshold V_{FW_th}” means when the value of forward open-phase voltage E1 increases from a value that is equal to or less than forward threshold V_{FW_th} to a value that is greater than forward threshold V_{FW_th}. The same applies to the expressions “when reverse open-phase voltage E2 falls below a reverse threshold V_{RV_th}” and “when reverse open-phase voltage E2 exceeds reverse threshold V_{RV_th}.

As described above, in energization mode [3], the forward pulse is a positive pulse, and the reverse pulse is a negative pulse. However, as illustrated in FIGS. 3 and 4, the forward pulse and the reverse pulse each alternately switch between a positive pulse and a negative pulse as the current energization mode sequentially changes among energization modes [1] to [6]. Thus, as illustrated in FIG. 6, as the current energization mode sequentially changes, forward open-phase voltage E1 alternately falls within a monotonically increasing section in which forward open-phase voltage E1 monotonically increases in the forward direction and falls within a monotonically decreasing section in which forward open-phase voltage E1 monotonically decreases in the forward direction. In addition, as illustrated in FIG. 7, as the current energization mode sequentially changes, reverse open-phase voltage E2 alternately falls within a monotonically increasing section in which reverse open-phase voltage E2 monotonically increases in the reverse direction and falls within a monotonically decreasing section in which reverse open-phase voltage E2 monotonically decreases in the reverse direction. Specifically, forward open-phase voltage E1 falls within a monotonically decreasing section in the forward direction in energization modes [1], [3], and [5], and falls within a monotonically increasing section in the forward direction in energization modes [2], [4], and [6]. In addition, reverse open-phase voltage E2 falls within a monotonically decreasing section in the reverse direction in energization modes [1], [3], and [5], and falls within a monotonically increasing section in the reverse direction in energization modes [2], [4], and [6]. Thus, two different thresholds are set as the above-described forward threshold V_{FW_th}, one being set for the individual monotonically increasing section and the other being set for the individual monotonically decreasing section. That is, in energization modes [2], [4], and [6] in which forward open-phase voltage E1 falls within a monotonically increasing section, an upper forward threshold (first upper threshold) V_{FW_th1} is set as forward threshold V_{FW_th}. On the other hand, in energization modes [1], [3], and [5] in which forward open-phase voltage E1 falls within a monotonically decreasing section, a lower forward threshold (first lower threshold) V_{FW_th2}, which is less than upper forward threshold V_{FW_th1}, is set as forward threshold V_{FW_th}. In addition, two different thresholds are set as the above-described reverse threshold V_{RV_th}, one being set for the individual monotonically increasing section and the other being set for the individual monotonically decreasing section. That is, in energization modes [1], [3], and [5] in which reverse open-phase voltage E2 falls within a monotonically increasing section, an upper reverse threshold (second upper threshold) V_{RV_th1} is set as reverse threshold V_{RV_th}. On the other hand, in energization modes [2], [4], and [6] in which reverse open-phase voltage E2 falls within a monotonically decreasing section, a lower reverse threshold (second lower threshold) V_{RV_th2}, which is less than upper reverse threshold V_{RV_th1}, is set as reverse threshold V_{RV_th}.

As described above, even when rotor 11 is rotating in the forward direction, motor control apparatus 3 detects not only forward open-phase voltage E1, but also reverse open-phase voltage E2. Similarly, even when rotor 11 is rotating in the reverse direction, motor control apparatus 3 detects not only reverse open-phase voltage E2, but also forward open-phase voltage E1. This is, in particular, to detect the inversion of the rotation direction of rotor 11 and to switch the energization mode to the inverted direction when application voltage command value V* is inverted.

### Specific Functions of Motor Control Apparatus

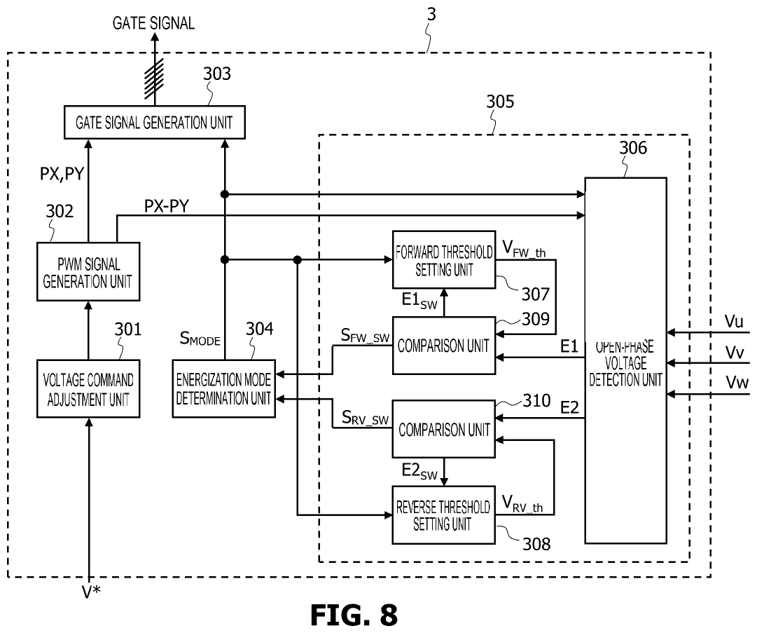

FIG. 8 illustrates an example of functional blocks relating to low-speed sensorless control of motor control apparatus 3. As its functions, motor control apparatus 3 includes: a control signal generation unit including a voltage command adjustment unit 301; a pulse width modulation (PWM) signal generation unit 302, and a gate signal generation unit 303; an energization mode determination unit 304; and a mode switching trigger generation unit 305. Basically, these functions are realized by causing processor 31 to read out a control program from non-volatile memory 33 to volatile memory 32 and to execute the control program. However, at least one of the functions of motor control apparatus 3 may be executed by hardware, irrespective of software processing.

Voltage command adjustment unit 301 acquires an adjustment command value by adjusting application voltage command value V*. By adjusting application voltage command value V*, voltage command adjustment unit 301 can generate a PWM signal such that a pulse voltage including a forward pulse and a reverse pulse can be applied, whether application voltage command value V* is a positive or a negative value. Voltage command adjustment unit 301 will be described in detail below.

PWM signal generation unit 302 generates a PWM signal PX and a PWM signal PY based on the adjustment command value obtained by voltage command adjustment unit 301. In addition, PWM signal generation unit 302 generates a line-to-line voltage signal [PX−PY] based on generated PWM signals PX and PY. PWM signal generation unit 302 will be described in detail below.

Gate signal generation unit 303 determines the two phases to which PWM signals PX and PY are applied, based on an energization mode signal S_{MODE} generated by energization mode determination unit 304 as will be described below, and generates gate signals for switching elements 21 to 26. Gate signal generation unit 303 will be described in detail below.

Energization mode determination unit 304 determines the next energization mode, based on a forward switching trigger signal S_{FW_SW} or a reverse switching trigger signal S_{RV_SW} generated by mode switching trigger generation unit 305, as will be described below, and generates energization mode signal S_{MODE} including information about the next energization mode. For example, when the current energization mode is energization mode [3], if forward switching trigger signal S_{FW_SW} is generated, energization mode determination unit 304 determines energization mode [4] as the next energization mode. On the other hand, when the current energization mode is energization mode [3], if reverse switching trigger signal S_{RV_SW} is generated, energization mode determination unit 304 determines energization mode [2] as the next energization mode.

Mode switching trigger generation unit 305 generates forward switching trigger signal S_{FW_SW} or reverse switching trigger signal S_{RV_SW}, based on signals about three-phase application voltages Vu, Vv, and Vw, based on line-to-line signal [PX−PY] and based on energization mode signal S_{MODE} generated by energization mode determination unit 304. Forward switching trigger signal S_{RV_SW} is generated at an energization mode switching timing in the forward direction, and reverse switching trigger signal S_{RV_SW} is generated at an energization mode switching timing in the reverse direction. More specifically, mode switching trigger generation unit 305 includes an open-phase voltage detection unit 306, a forward threshold setting unit 307, a reverse threshold setting unit 308, a comparison unit 309, and a comparison unit 310.

Open-phase voltage detection unit 306 separately detects forward open-phase voltage E1 and reverse open-phase voltage E2 as the open-phase voltages, based on three-phase application voltages Vu, Vv, and Vw, energization mode signal S_{MODE}, and line-to-line voltage signal [PX−PY]. Open-phase voltage detection unit 306 will be described in detail below.

Forward threshold setting unit 307 sets either one of upper forward threshold V_{FW_th1} and lower forward threshold V_{FW_th2}, which are set in advance as forward initial thresholds (first initial thresholds), as forward threshold V_{FW_th}, based on energization mode signal S_{MODE}. Reverse threshold setting unit 308 sets either one of upper reverse threshold V_{RV_th1} and lower reverse threshold V_{RV_th2}, which are set in advance as reverse initial thresholds (second initial thresholds), as reverse threshold V_{RV_th}, based on energization mode signal S_{MODE}.

Comparison unit 309 compares forward open-phase voltage value E1 with forward threshold V_{FW_th}, and generates forward switching trigger signal S_{FW_SW}, based on the comparison result. Comparison unit 310 compares reverse open-phase voltage value E2 with reverse threshold V_{RV_th}, and generates reverse switching trigger signal S_{RV_SW}, based on the comparison result.

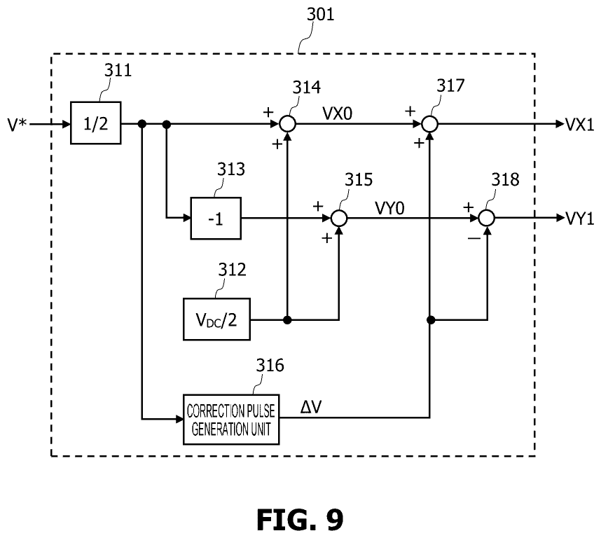

FIG. 9 illustrates a detailed configuration example of voltage command adjustment unit 301. Voltage command adjustment unit 301 includes multiplication units 311 and 312, a sign inversion unit 313, addition units 314 and 315, a correction pulse generation unit 316, an addition unit 317, and a subtraction unit 318.

Multiplication unit 311 calculates [V*/2] by multiplying application voltage command value V* by 0.5. Multiplication unit 312 calculates [V_{DC}/2] by multiplying a detected value of DC voltage V_{DC} of in-vehicle battery 4 by 0.5. Sign inversion unit 313 acquires [−V*/2] by inverting the sign of [V*/2]. Addition unit 314 acquires an offset command value VX0 by adding [V*/2] to [V_{DC}/2], and addition unit 315 acquires an offset command value VY0 by adding [−V*/2] to [V_{DC}/2]. Correction pulse generation unit 316 generates a correction pulse signal on which a correction amount ΔV for correcting offset command values VX0 and VY0 has been reflected, such that a forward pulse and a reverse pulse are generated in line-to-line voltages Vuv, Vvw, and Vwu in the individual energization mode. Addition unit 317 acquires an adjustment command value VX1 by adding correction amount ΔV of the correction pulse signal to offset command value VX0, and subtraction unit 318 acquires an adjustment command value VY1 by subtracting correction amount ΔV of the correction pulse signal from offset command value VY0. These adjustment command values VX1 and VY1 are final application voltage command values.

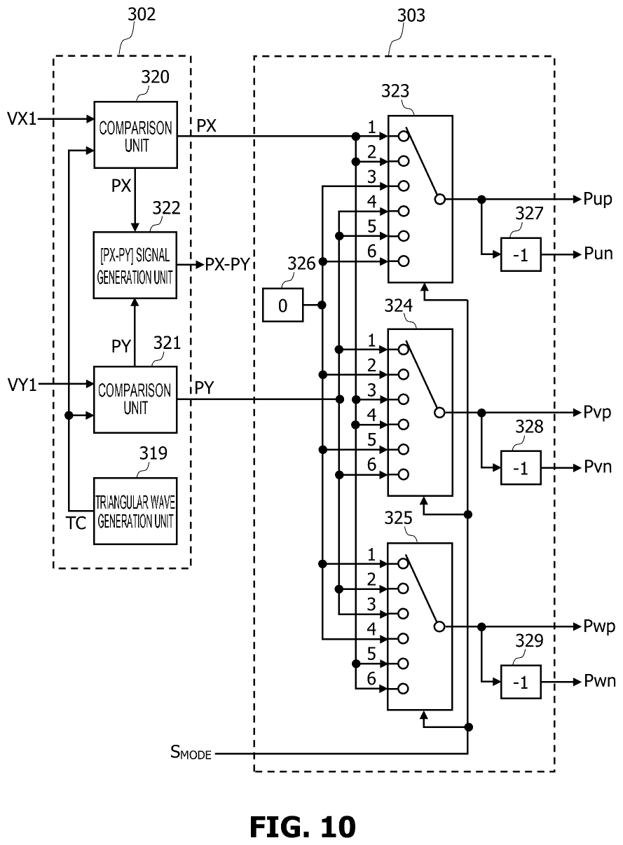

FIG. 10 illustrates a detailed configuration example of PWM signal generation unit 302 and gate signal generation unit 303.

PWM signal generation unit 302 includes a triangular wave generation unit 319 that generates a triangular wave carrier TC, a comparison unit 320 that compares adjustment command value VX1 with triangular wave carrier TC, and comparison unit 321 that compares adjustment command value VY1 with triangular wave carrier TC. Comparison unit 320 generates PWM signal PX as a result of the comparison between adjustment command value VX1 and triangular wave carrier TC, and comparison unit 321 generates PWM signal PY as a result of the comparison between adjustment command value VY1 and triangular wave carrier TC. Either one of PWM signals PX and PY is a pulse signal having a rectangular waveform indicated by two potentials of a high-potential (H) level and a low-potential (L) level.

In addition, PWM signal generation unit 302 includes a [PX−PY] signal generation unit 322. [PX−PY] signal generation unit 322 generates line-to-line voltage signal [PX−PY] by subtracting the potential of PWM signal PY from the potential of PWM signal PX. Line-to-line voltage signal [PX−PY] is a bipolar pulse signal indicated by three potentials of a positive level (P level), a zero level, and a negative level (N level) in descending order.

Gate signal generation unit 303 includes a U-phase switching unit 323, a V-phase switching unit 324, a W-phase switching unit 325, a zero signal generation unit 326, and inversion units 327, 328, and 329. U-phase switching unit 323, V-phase switching unit 324, and W-phase switching unit 325 each select a different signal, based on energization mode signal S_{MODE}, PWM signal PX, PWM signal PY, and a zero signal of a zero potential (for example, a ground potential) generated by signal generation unit 326. Specifically, U-phase switching unit 323 selects PWM signal PX in energization modes [1] and [2], selects PWM signal PY in energization modes [4] and [5], and selects the zero signal in energization modes [3] and [6]. V-phase switching unit 324 selects PWM signal PX in energization modes [3] and [4], selects PWM signal PY in energization modes [1] and [6], and selects the zero signal in energization modes [2] and [5]. W-phase switching unit 325 selects PWM signal PX in energization modes [5] and [6], selects PWM signal PY in energization modes [2] and [3], and selects the zero signal in energization modes [1] and [4]. In short, when application voltage command value V* is a positive value, for the two phases through which a line-to-line current flows in the individual energization mode, PWM signal PX is used as the gate signal of the individual upstream-phase switching element, and PWM signal PY is used as the gate signal of the individual downstream-phase switching element. When application voltage command value V* is a negative value, for the two phases through which a line-to-line current flows in the individual energization mode, PWM signal PY is used for the individual upstream-phase switching element, and PWM signal PX is used for the individual downstream-phase switching element.

The signal selected by U-phase switching unit 323 is output as a gate signal Pup of upper-arm switching element 21 of the U phase, and is output as a gate signal Pun of lower-arm switching element 22 of the U phase via inversion unit 327. The signal selected by V-phase switching unit 324 is output as a gate signal Pvp of upper-arm switching element 23 of the V phase, and is output as a gate signal Pvn of lower-arm switching element 24 of the U phase via inversion unit 328. The signal selected by W-phase switching unit 325 is output as a gate signal Pwp of upper-arm switching element 25 of the W phase, and is output as a gate signal Pwn of lower-arm switching element 26 of the U phase via inversion unit 329. Except for the zero signal, inversion units 327, 328, and 329 each generate a complementary PWM signal by switching the potential level of PWM signal PX or PY.

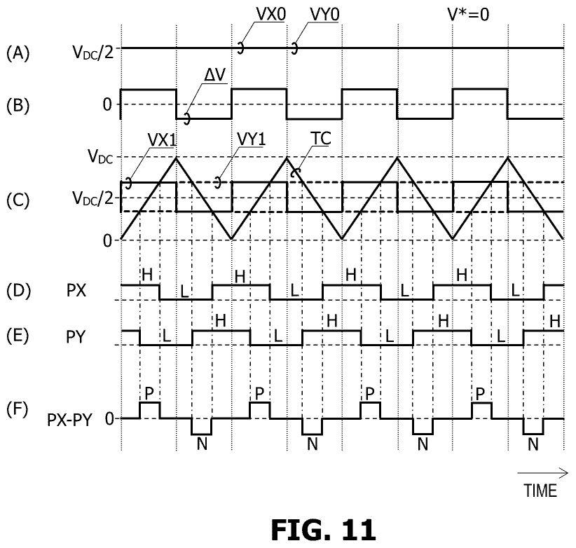

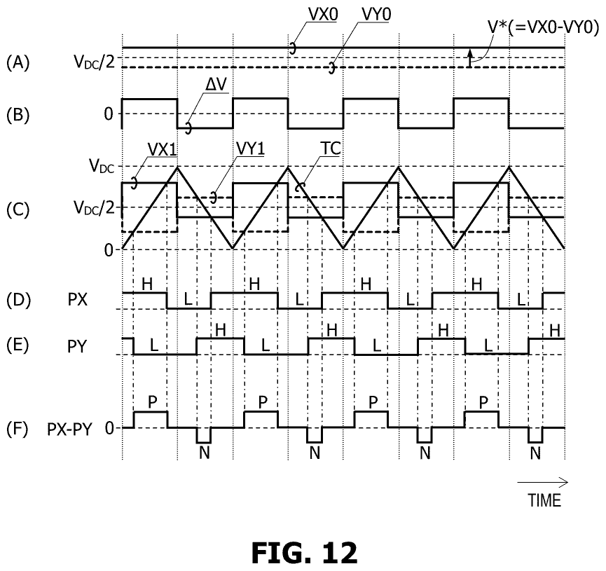

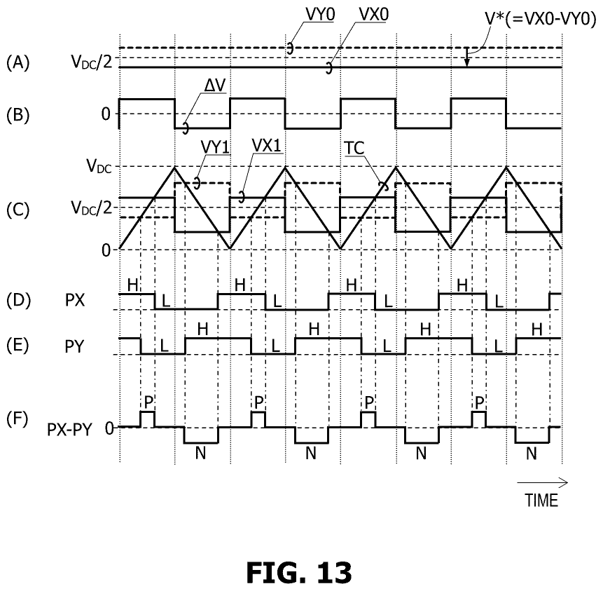

Control signal waveforms relating to voltage command adjustment unit 301 and PWM signal generation unit 302 will be described with reference to FIGS. 11 to 13. FIG. 11 illustrates an example of control signal waveforms when application voltage command value V* is zero. FIG. 12 illustrates an example of control signal waveforms when application voltage command value V* is a positive value. FIG. 13 illustrates an example of control signal waveforms when application voltage command value V* is a negative value. In each of FIGS. 11 to 13, (A) indicates application voltage command value V*, (B) indicates the correction pulse signal, (C) indicates triangular wave carrier TC and adjustment command values VX1 and VY1, (D) indicates PWM signal PX, (E) indicates PWM signal PY, and (F) indicates line-to-line voltage signal [PX−PY].

As illustrated in (A) of FIG. 11, when application voltage command value V* is zero, offset command values VX0 and VY0 are [V_{DC}/2]. As illustrated in (B) of FIG. 11, the correction pulse signal synchronizes with the periodicity of triangular wave carrier TC (see (C) in FIG. 11). Correction amount ΔV represents a positive value in the first half of the cycle, which is before each peak of triangular wave carrier TC, and represents a negative value in the second half of the cycle, which is after each peak of triangular wave carrier TC. That is, correction amount ΔV is a bipolar pulse signal having a rectangular waveform. Correction amount ΔV of the correction pulse signal is added to offset command value VX0, so as to generate adjustment command value VX1. In addition, correction amount ΔV is subtracted from offset command value VY0, so as to generate adjustment command value VY1. In this way, adjustment command values VX1 and VY1 as illustrated in (C) of FIG. 11 are obtained. Adjustment command values VX1 and VY1 have the same pulse width as that of the correction pulse signal, and are pulse signals having waveforms that are inverted with respect to each other. However, the individual timing at which the pulse signal of adjustment command value VX1 matches triangular wave carrier TC and the individual timing at which the pulse signal of adjustment command value VY1 matches triangular wave carrier TC are different from each other. Thus, as illustrated in (D) and (E) of FIG. 11, the H level period of PWM signal PX overlaps the L level period of PWM signal PY in some periods. In addition, the L level period of PWM signal PX overlaps the H level period PWM PY in some periods. As a result, as illustrated in (F) of FIG. 11, line-to-line voltage signal [PX−PY] represents a P level when PWM signal PX is an H level and PWM signal PY is an L level, and represents an N level when PWM signal PX is an L level and PWM signal PY is an H level.

The waveform of line-to-line voltage signal [PX−PY] illustrated in (F) of FIG. 11 corresponds to the waveform obtained when the pulse width of the individual forward pulse of any one of line-to-line voltages Vuv, Vvw, and Vwu in FIG. 3 matches the pulse width of the corresponding reverse pulse. The waveform of line-to-line voltage signal [PX−PY] illustrated in (F) of FIG. 11 also corresponds to the waveform obtained when the pulse width of the individual reverse pulse of any one of line-to-line voltages Vuv, Vvw, and Vwu in FIG. 4 matches the pulse width of the corresponding forward pulse.

As illustrated in (A) of FIG. 12, when application voltage command value V* is a positive value, application voltage command value V* is represented by the difference [VX0−VY0] between offset command value VX0 obtained by adding [V*/2] to [V_{DC}/2] and offset command value VY0 (<VX0) obtained by subtracting [V*/2] from [V_{DC}/2]. Correction amount ΔV of the correction pulse signal illustrated in (B) of FIG. 12 (same as that in (B) of FIG. 11) is added to offset command value VX0, and consequently, the pulse signal of adjustment command value VX1 illustrated in (C) of FIG. 12 is generated. In addition, correction amount ΔV of the correction pulse signal illustrated in (B) of FIG. 12 is subtracted from offset command value VY0, and consequently, the pulse signal of adjustment command value VY1 illustrated in (C) of FIG. 12 is generated. The individual timing at which the pulse signal of adjustment command value VX1 matches triangular wave carrier TC is located closer to the corresponding peak timing of triangular wave carrier TC, compared with the pulse signal of adjustment command value VX1 illustrated in (C) of FIG. 11. In addition, the individual timing at which the pulse signal of adjustment command value VY1 matches triangular wave carrier TC is located farther away from the corresponding peak timing of triangular wave carrier TC, compared with the pulse signal of adjustment command value VY1 illustrated in (C) of FIG. 11. Thus, as illustrated in (D) and (E) of FIG. 12, the individual period in which the H level period of PWM signal PX overlaps the L level period of PWM signal PY is extended, and the individual period in which the L level period of PWM signal PX overlaps the H level period of PWM signal PY is shortened. Thus, as illustrated in (F) of FIG. 12, the individual P level period in which line-to-line voltage signal [PX−PY] represents the P level is longer and the individual N level period in which line-to-line voltage signal [PX−PY] represents the N level is shorter, compared with line-to-line voltage signal [PX−PY] illustrated in (F) of FIG. 11.

The waveform of line-to-line voltage signal [PX−PY] illustrated in (F) of FIG. 12 corresponds to the waveforms of line-to-line voltage Vuv in energization mode [1], line-to-line voltage Vvw in energization mode [3], and line-to-line voltage Vwu in energization mode [5] in FIG. 3, and corresponds to the inverted waveforms of the waveforms of line-to-line voltage Vuv in energization mode [2], line-to-line voltage Vvw in energization mode [4], and line-to-line voltage Vwu in energization mode [6] in FIG. 3. That is, a forward pulse is applied in the individual P level period of line-to-line voltage signal [PX−PY], and a reverse pulse is applied in the individual N level period of line-to-line voltage signal [PX−PY].

As illustrated in (A) of FIG. 13, when application voltage command value V* is a negative value, application voltage command value V* is represented by the difference [VX0−VY0] between offset command value VX0 obtained by adding [V*/2] to [V_{DC}/2] and offset command value VY0 (>VX0) obtained by subtracting [V*/2] from [V_{DC}/2]. Correction amount ΔV of the correction pulse signal illustrated in (B) of FIG. 13 (same as that in (B) of FIG. 11) is added to offset command value VX0, and consequently, the pulse signal of adjustment command value VX1 illustrated in (C) of FIG. 13 is generated. In addition, correction amount ΔV of the correction pulse signal illustrated in (B) of FIG. 13 is subtracted from offset command value VY0, and consequently, the pulse signal of adjustment command value VY1 illustrated in (C) of FIG. 13 is generated. The individual timing at which the pulse signal of adjustment command value VX1 matches triangular wave carrier TC is farther away from the corresponding peak timing of triangular wave carrier TC, compared with the pulse signal of adjustment command value VX1 illustrated in (C) of FIG. 11. The individual timing at which the pulse signal of adjustment command value VY1 matches triangular wave carrier TC is located closer to the corresponding peak timing of triangular wave carrier TC, compared with the pulse signal of adjustment command value VY1 illustrated in (C) of FIG. 11. Thus, as illustrated in (D) and (E) of FIG. 13, the individual period in which the H level period of PWM signal PX overlaps the L level period of PWM signal PY is shortened, and the individual period in which the L level period of PWM signal PX overlaps the H level period of PWM signal PY is extended. Thus, as illustrated in (F) of FIG. 13, the individual P level period of line-to-line voltage signal [PX−PY] is shorter and the individual N level period of line-to-line voltage signal [PX−PY] is longer, compared with line-to-line voltage signal [PX−PY] illustrated in (F) of FIG. 11.

The waveform of line-to-line voltage signal [PX−PY] illustrated in (F) of FIG. 13 corresponds to the waveforms of line-to-line voltage Vuv in energization mode [1], line-to-line voltage Vvw in energization mode [3], and line-to-line voltage Vwu in energization modes [5] in FIG. 4, and corresponds to the inverted waveforms of the waveforms of line-to-line voltage Vuv in energization mode [2], line-to-line voltage Vvw in energization mode [4], and line-to-line voltage Vwu in energization mode [6] in FIG. 4. That is, a forward pulse is applied in the individual P level period of line-to-line voltage signal [PX−PY], and a reverse pulse is applied in the individual N level period of line-to-line voltage signal [PX−PY].

As described with reference to FIGS. 11 to 13, in the individual P level period of line-to-line voltage signal [PX−PY], a forward pulse is applied as line-to-line voltages Vuv, Vvw, and Vwu. In the individual N level period of line-to-line voltage signal [PX−PY], a reverse pulse is applied as line-to-line voltages Vuv, Vvw, and Vwu.

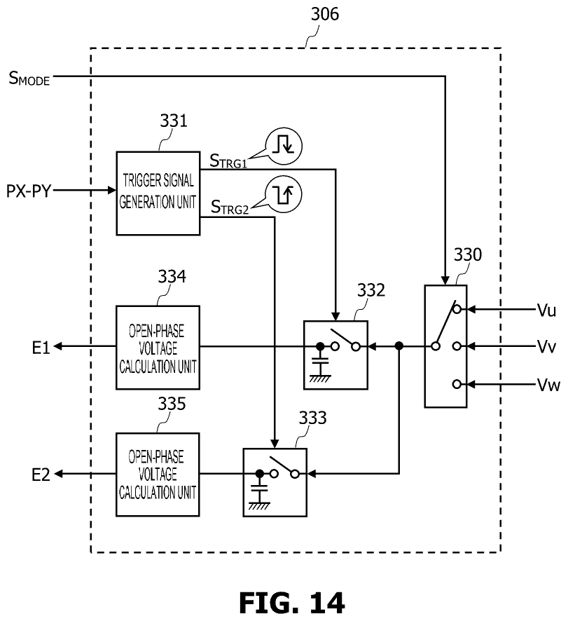

FIG. 14 illustrates a detailed configuration example of open-phase voltage detection unit 306. Open-phase voltage detection unit 306 includes a three-phase application voltage selection unit 330, a trigger signal generation unit 331, sampling units 332 and 333, and open-phase voltage calculation units 334 and 335.

Three-phase application voltage selection unit 330 selects one of three-phase application voltages Vu, Vv, and Vw, based on energization mode signal S_{MODE}. That is, three-phase application voltage selection unit 330 selects U-phase application voltage Vu in energization mode [3] or [6], selects V-phase application voltage Vv in energization mode [2] or [5], and selects W-phase application voltage Vw in energization mode [1] or [4].

Trigger signal generation unit 331 generates a trigger signal, which indicates the sampling timing of the application voltage of the phase (U-phase application voltage Vu in FIG. 14) selected by three-phase application voltage selection unit 330, based on line-to-line voltage signal [PX−PY]. Specifically, when trigger signal generation unit 331 detects that line-to-line voltage signal [PX−PY] is in a P level period, trigger signal generation unit 331 generates a forward pulse trigger signal S_{TRG1}. When trigger signal generation unit 331 detects that line-to-line voltage signal [PX−PY] is in an N level period, trigger signal generation unit 331 generates a reverse pulse trigger signal S_{TRG2}.

Sampling unit 332 executes sampling of the application voltage, which has been selected by three-phase application voltage selection unit 330 from the three-phase application voltages Vu, Vv, and Vw, based on forward pulse trigger signal S_{TRG1} generated by trigger signal generation unit 331, by executing analog-to-digital (A/D) conversion, for example. Sampling unit 333 executes sampling of the application voltage, which has been selected by three-phase application voltage selection unit 330 from the three-phase application voltages Vu, Vv, and Vw, based on reverse pulse trigger signal S_{TRG2} generated by trigger signal generation unit 331, by executing A/D conversion, for example. Sampling units 332 and 333 may include a capacitor that holds the sampling target application voltage for a certain time.

Open-phase voltage calculation unit 334 calculates an open-phase voltage value based on the application voltage sampled by sampling unit 332 and the potential of neutral point 12N, and detects this value as forward open-phase voltage E1. Open-phase voltage calculation unit 335 calculates an open-phase voltage value based on the application voltage sampled by sampling unit 333 and the potential of neutral point 12N, and detects this value as reverse open-phase voltage E2.

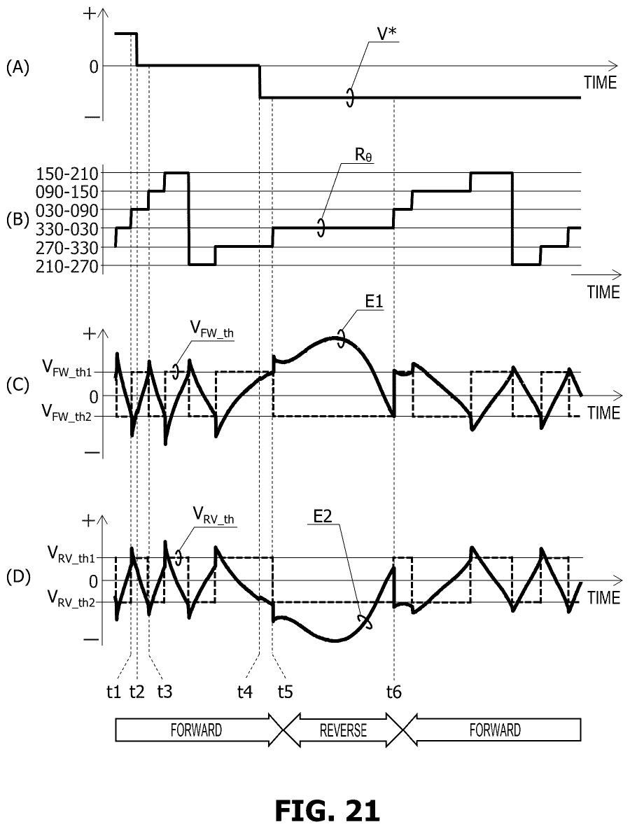

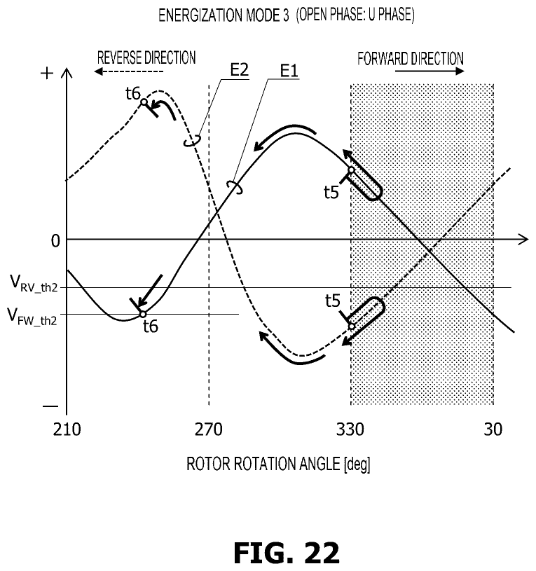

Hereinafter, a conventional problem with motor control apparatus 3 configured as described above will be described with reference to FIGS. 21 and 22. FIG. 21 schematically illustrates a conventional operation example of electric motor 1 when motor control apparatus 3 executes low-speed sensorless control. Specifically, in FIG. 21, (A) illustrates change of application voltage command value V* over time, (B) illustrates change of rotor rotation angle range R_{θ} detected by motor control apparatus 3 over time, (C) illustrates change of forward open-phase voltage E1 over time, and (D) illustrates change of reverse open-phase voltage E2 over time. FIG. 22 illustrates change of forward open-phase voltage E1 and reverse open-phase voltage E2 with respect to the rotor rotation angle between time t5 and time t6 in FIG. 21.

As illustrated in (A) of FIG. 21, application voltage command value V* is a positive value representing a forward drive command until time t2. Application voltage command value V* changes to zero representing a drive stop command at time t2, and changes to a negative value representing a reverse drive command at time t4.

Immediately before time t1, as illustrated in (B) of FIG. 21, motor control apparatus 3 has detected that rotor rotation angle range R_{θ} is the range from 330° to 30°, and a pulse voltage is applied to electric motor 1 in energization mode [3] (see FIGS. 3 and 6). Since the individual P level period of line-to-line voltage signal [PX−PY] is longer than the individual N level period, the pulse width of the forward pulse of line-to-line voltage Vvw is longer than the pulse width of the reverse pulse. Thus, a line-to-line current flows from the V phase to the W phase, and forward drive is being executed (see FIG. 3). Forward open-phase voltage E1 is calculated based on U-phase application voltage Vu during the application of the forward pulse, and monotonically decreases as illustrated in (C) of FIG. 21 (see FIGS. 3, 6, and 14).

Assuming that the value of forward open-phase voltage E1 falls below lower forward threshold V_{FW_th2} at time t1 as illustrated in (C) of FIG. 21, motor control apparatus 3 determines that rotor rotation angle range R_{θ} has shifted from the range from 330° to 30° to the range from 30° to 90° as illustrated in (B) of FIG. 21, and switches the current energization mode from energization mode [3] to energization mode [4] (see FIG. 6). As a result, forward open-phase voltage E1 is calculated based on W-phase application voltage Vw during the application of the forward pulse, and monotonically increases as illustrated in (C) of FIG. 21 (see FIGS. 3, 6, and 14).

When application voltage command value V* represents zero at time t2, the P level period and the N level period of line-to-line voltage signal [PX−PY] represent the same length (see (F) of FIG. 11). As a result, the pulse width of the forward pulse of line-to-line voltage Vuv is shortened and matches the pulse width of the reverse pulse, and the line-to-line current from V phase to the U phase substantially becomes zero, whereby the forward drive is stopped. Even after the forward drive is stopped, rotor 11 is continuously rotated in the forward direction by inertia, and the switching control of the energization mode is continuously executed in this drive stop state.

When the value of forward open-phase voltage E1 exceeds upper forward threshold V_{FW_th1} at time t3 as illustrated in (C) of FIG. 21, motor control apparatus 3 determines that rotor rotation angle range R_{θ} has shifted to the range from 90° to 150°, and switches the current energization mode from energization mode [4] to energization mode [5]. Thereafter, as long as rotor 11 is continuously rotated in the forward direction by inertia, motor control apparatus 3 sequentially switches the current energization mode from [6], [1], [2] . . . in this order.

While rotor 11 is rotating in the forward direction, as illustrated in (D) of FIG. 21, in the energization modes in which upper reverse threshold V_{RV_th1} is set as reverse threshold V_{RV_th}, the value of reverse open-phase voltage E2 does not exceed upper reverse threshold V_{RV_th1} (see FIG. 7). In addition, while rotor 11 is rotating in the forward direction, as illustrated in (D) of FIG. 21, in the energization modes in which lower reverse threshold V_{RV_th2} is set as reverse threshold V_{RV_th}, the value of reverse open-phase voltage E2 does not fall below lower reverse threshold V_{RV_th2} (see FIG. 7). Thus, while rotor 11 is rotating in the forward direction, the energization mode is not switched to the reverse direction.

At time t4, as illustrated in (B) of FIG. 21, motor control apparatus 3 detects that rotor rotation angle range R_{θ} is the range from 270° to 330°, and a pulse voltage is applied to electric motor 1 in energization mode [2]. At this time t4, when application voltage command value V* changes to a negative value, the N level period of line-to-line voltage signal [PX−PY] becomes longer than the P level period. As a result, the pulse width of the reverse pulse of line-to-line voltage Vwu becomes longer than the pulse width of the forward pulse, a line-to-line current flows from the W phase to the U phase, and reverse drive is started (see FIG. 4). The present example assumes that at this point of time, rotor 11 is still rotating in the forward direction by inertia.

At time t5, when the value of forward open-phase voltage E1 exceeds upper forward threshold V_{FW_th1} by the forward rotation of rotor 11, motor control apparatus 3 determines that rotor rotation angle range R_{θ} is the range from 330° to 30°, and switches the current energization mode from energization mode [2] to energization mode [3]. The present example assumes that the rotation of rotor 11 is changed from the forward rotation to the reverse rotation while a pulse voltage is being applied in energization mode [3].

As illustrated in (D) of FIG. 21 and FIG. 22, when motor control apparatus 3 switches the current energization mode from energization mode [2] to energization mode [3] at time t5, there are cases in which the value of reverse open-phase voltage E2 is already below lower reverse threshold V_{RV_th2}. This is a phenomenon that occurs due to individual variability among electric motors 1, physical variation within electric motor 1, or electrical noise, for example. If this phenomenon occurs, that is, when the reverse rotation of rotor 11 is started, if the value of reverse open-phase voltage E2 is below lower reverse threshold V_{RV_th2} as illustrated in (D) of FIG. 21 and FIG. 22, the value of reverse open-phase voltage E2 cannot fall below lower reverse threshold V_{RV_th2}. Thus, when rotor 11 begins the reverse drive in the forward state, motor control apparatus 3 cannot successfully detect the switching timing from energization mode [3] to energization mode [2], whereby the loss of synchronization occurs due to the inversion of the rotation direction.

Even if the loss of synchronization occurs due to the inversion of the rotation direction, application of a pulse voltage in energization mode [3] reverses rotor 11, and changes forward open-phase voltage E1 and reverse open-phase voltage E2 to the reverse direction as illustrated in FIG. 22. Because motor control apparatus 3 recognizes that rotor rotation angle range R_{θ} is still the range from 330° to 30°, motor control apparatus 3 continues to detect the switching timing of the energization mode with lower forward threshold V_{FW_th2} and lower reverse threshold V_{RV_th2} corresponding to energization mode [3]. Next, as illustrated in (C) and (D) of FIG. 21 and FIG. 22, when actual rotation angle range R_{θ} of rotor 11 changes to the range from 210° to 270° at time t6, before the value of reverse open-phase voltage E2 falls below lower reverse threshold V_{RV_th2}, the value of forward open-phase voltage E1 falls below lower forward threshold V_{FW_th2}. Thus, motor control apparatus 3 determines that rotor rotation angle range R_{θ} is the range from 30° to 90°, and switches the current energization mode from energization mode [3] to energization mode [4]. As a result, the rotation of rotor 11 is changed from the reverse rotation to the forward rotation. This time, before the value of reverse open-phase voltage E2 exceeds upper reverse threshold V_{RV_th1}, if the value of forward open-phase voltage E1 exceeds upper forward threshold V_{FW_th1}, motor control apparatus 3 switches the current energization mode from energization mode [4] to energization mode [5]. As described above, if the loss of synchronization occurs due to the inversion of the rotation direction, although motor control apparatus 3 has received a reverse drive command, rotor 11 is rotated in the forward direction. Under some conditions, the rotation of rotor 11 may stop.

In the above description, the loss of synchronization due to the inversion of the rotation direction occurs when reverse open-phase voltage E2 immediately after the current energization mode is switched from [2] to [3] in the forward direction is less than lower reverse threshold V_{RV_th2}. However, the loss of synchronization occurs in other cases, too. That is, the loss of synchronization due to the inversion of the rotation direction also occurs when reverse open-phase voltage E2 immediately after the current energization mode is switched from [4] to [5] or from [6] to [1] in the forward direction is below lower reverse threshold V_{RV_th2}. In addition, in the above description, the loss of synchronization due to the inversion of the rotation direction occurs when reverse open-phase voltage E2 immediately after the current energization mode is switched in the forward direction is less than lower reverse threshold V_{RV_th2}. However, the loss of synchronization occurs in other cases, too. That is, the loss of synchronization due to the inversion of the rotation direction also occurs when reverse open-phase voltage E2 immediately after the current energization mode is switched from [1] to [2], from [3] to [4], or from [5] to [6] in the forward direction is greater than upper reverse threshold V_{RV_th1}.

In addition, in the above description, the loss of synchronization due to the inversion of the rotation direction occurs when the reverse drive is started in the forward state of rotor 11. However, the loss of synchronization could also occur when the forward drive is started in the reverse state of rotor 11. That is, the loss of synchronization due to the inversion of the rotation direction also occurs when forward open-phase voltage E1 immediately after the current energization mode is switched from [1] to [6], from [3] to [2], or from [5] to [4] in the reverse direction is greater than upper forward threshold V_{FW_th1}. In addition, the loss of synchronization due to the inversion of the rotation direction also occurs when forward open-phase voltage E1 immediately after the current energization mode is switched from [2] to [1], from [4] to [3], or from [6] to [5] is less than lower forward threshold V_{FW_th2}.

In view of the conventional problem with motor control apparatus 3 constructed as described above, motor control apparatus 3 according to the present example is constructed as follows. That is, as illustrated in FIG. 8, forward threshold setting unit 307 sets forward threshold V_{FW_th}, based on not only energization mode signal S_{MODE}, but also the value of forward open-phase voltage E1 (a first switching time detection value E1_{SW}) detected by open-phase voltage unit 306 (comparison unit 334) immediately after the energization mode is switched and received via comparison unit 309. In addition, as illustrated in FIG. 8, reverse threshold setting unit 308 sets reverse threshold V_{RV_th}, based on not only energization mode signal S_{MODE}, but also the value of reverse open-phase voltage E2 (a second switching time detection value E2_{SW}) detected by open-phase voltage unit 306 (comparison unit 335) immediately after the energization mode is switched and received via comparison 310.

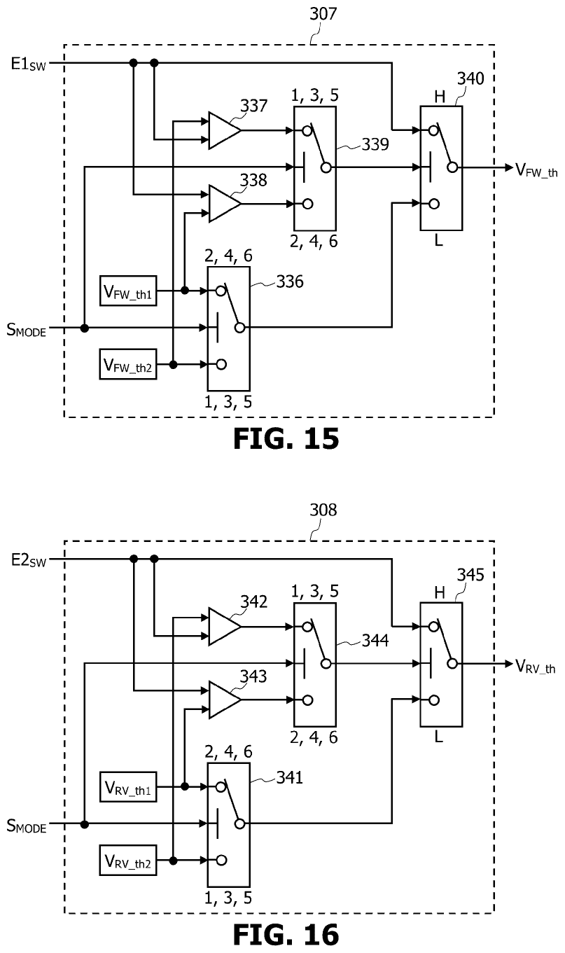

Next, a detailed setting method of forward threshold V_{FW_th} and reverse threshold V_{RV_th} will be described with reference to FIGS. 15 and 16. FIG. 15 illustrates a detailed functional configuration example of forward threshold setting unit 307, and FIG. 16 illustrates a detailed functional configuration example of reverse threshold setting unit 308.

As illustrated in FIG. 15, forward threshold setting unit 307 includes an initial threshold selection unit 336, comparison units 337 and 338, a comparison result selection unit 339, and a switching unit 340. Initial threshold selection unit 336 selects one of upper forward threshold V_{FW_th1} and lower forward threshold V_{FW_th2} that are set in advance as the forward initial thresholds, based on energization mode signal S_{MODE}. Specifically, initial threshold selection unit 336 selects upper forward threshold V_{FW_th1} when the current energization mode is energization mode [2], [4], or [6], and selects lower forward threshold V_{FW_th2} when the current energization mode is energization mode [1], [3], or [5]. Comparison unit 337 compares lower forward threshold V_{FW_th2} with first switching time detection value E1_{SW}, and generates an output signal based on the comparison result. Specifically, when lower forward threshold V_{FW_th2} is greater than first switching time detection value E1_{SW}, comparison unit 337 generates a high-potential (H) output signal. On the other hand, when lower forward threshold V_{FW_th2} is equal to or less than first switching time detection value E1_{SW}, comparison unit 337 generates a low-potential (L) output signal. Comparison unit 338 compares first switching time detection value E1_{SW} with upper forward threshold V_{FW_th1}, and generates an output signal based on the comparison result. Specifically, when first switching time detection value E1_{SW} is greater than upper forward threshold V_{FW_th1}, comparison unit 338 generates a high-potential (H) output signal. On the other hand, when first switching time detection value E1_{SW} is equal to or less than upper forward threshold V_{FW_th1}, comparison unit 338 generates a low-potential (L) output signal. Comparison result selection unit 339 selects the comparison result obtained by comparison unit 337 or the comparison result obtained by comparison unit 338, based on energization mode signal S_{MODE}. Specifically, comparison result selection unit 339 selects the output signal of comparison unit 337 when the current energization mode is energization mode [1], [3], or [5], and selects the output signal of comparison unit 338 when the current energization mode is energization mode [2], [4], or [6]. Switching unit 340 selects first switching time detection value E1_{SW} or the forward initial threshold selected by initial threshold selection unit 336, based on the output signal selected by comparison result selection unit 339, and sets the selected value as forward threshold V_{FW_th}. Specifically, when the output signal selected by comparison result selection unit 339 represents a high potential (H), switching unit 340 sets first switching time detection value E1_{SW} as forward threshold V_{FW_th}. On the other hand, when the output signal selected by comparison result selection unit 339 represents a low potential (L), switching unit 340 sets the forward initial threshold selected by initial threshold selection unit 336 as forward threshold V_{FW_th}.

In short, when the current energization mode is energization mode [1], [3], or [5], forward threshold setting unit 307 sets forward threshold V_{FW_th} as follows. That is, when first switching time detection value E1_{SW} is less than lower forward threshold V_{FW_th2}, forward threshold setting unit 307 sets first switching time detection value E1_{SW} as forward threshold V_{FW_th}. On the other hand, when first switching time detection value E1_{SW} is equal to or greater than lower forward threshold V_{FW_th2}, forward threshold setting unit 307 sets lower forward threshold V_{FW_th2} as forward threshold V_{FW_th}.

In addition, when the current energization mode is energization mode [2], [4], or [6], forward threshold setting unit 307 sets forward threshold V_{FW_th} as follows. That is, when first switching time detection value E1_{SW} is greater than upper forward threshold V_{FW_th1}, forward threshold setting unit 307 sets first switching time detection value E1_{SW} as forward threshold V_{FW_th}. On the other hand, when first switching time detection value E1_{SW} is equal to or less than upper forward threshold V_{FW_th1}, forward threshold setting unit 307 sets upper forward threshold V_{FW_th1} as forward threshold V_{FW_th}.

As illustrated in FIG. 16, reverse threshold setting unit 308 includes an initial threshold selection unit 341, comparison units 342 and 343, a comparison result selection unit 344, and a switching unit 345. Initial threshold selection unit 341 selects one of upper reverse threshold V_{RV_th1} and lower reverse threshold V_{RV_th2} that are set in advance as the reverse initial thresholds, based on energization mode signal S_{MODE}. Specifically, initial threshold selection unit 341 selects upper reverse threshold V_{RV_th1} when the current energization mode is energization mode [2], [4], or [6], and selects lower reverse threshold V_{RV_th2} when the current energization mode is energization mode [1], [3], or [5]. Comparison unit 342 compares lower reverse threshold V_{RV_th2} with second switching time detection value E2_{SW}, and generates an output signal based on the comparison result. Specifically, when lower reverse threshold V_{RV_th2} is greater than second switching time detection value E2_{SW}, comparison unit 342 generates a high-potential (H) output signal. On the other hand, when lower reverse threshold V_{RV_th2} is equal to or less than second switching time detection value E2_{SW}, comparison unit 342 generates a low-potential (L) output signal. Comparison unit 343 compares second switching time detection value E2_{SW} with upper reverse threshold V_{RV_th1}, and generates an output signal based on the comparison result. Specifically, when second switching time detection value E2_{SW} is greater than upper reverse threshold V_{RV_th1}, comparison unit 343 generates a high-potential (H) output signal. Comparison unit 343 generates a low-potential (L) output signal when second switching time detection value E2_{SW} is equal to or less than upper reverse threshold V_{RV_th1}. Comparison result selection unit 344 selects the comparison result obtained by comparison unit 342 or the comparison result obtained by comparison unit 343, based on energization mode signal S_{MODE}. Specifically, when the current energization mode is energization mode [1], [3], or [5], comparison result selection unit 344 selects the output signal of comparison unit 342. When the current energization mode is energization mode [2], [4], or [6], comparison result selection unit 344 selects the output signal of comparison unit 343. Switching unit 345 selects second switching time detection value E2_{SW} or the reverse initial threshold selected by initial threshold selection unit 341, based on the output signal selected by comparison result selection unit 344, and sets the selected value as reverse threshold V_{RV_th}. Specifically, when the output signal selected by comparison result selection unit 344 represents a high potential (H), switching unit 345 sets second switching time detection value E2_{SW} as reverse threshold V_{RV_th}. On the other hand, when the output signal selected by comparison result selection unit 344 represents a low potential (L), switching unit 345 selects the reverse initial threshold selected by initial threshold selection unit 341 as reverse threshold V_{RV_th}.

In short, when the current energization mode is energization mode [1], [3], or [5], reverse threshold setting unit 308 sets reverse threshold V_{RV_th} as follows. That is, when second switching time detection value E2_{SW} is less than lower reverse threshold V_{RV_th2}, reverse threshold setting unit 308 sets second switching time detection value E2_{SW} as reverse threshold V_{RV_th}. On the other hand, when second switching time detection value E2_{SW} is equal to or less than lower reverse threshold V_{RV_th2}, reverse threshold setting unit 308 sets lower reverse threshold V_{RV_th2} as reverse threshold V_{RV_th}.

In addition, when the current energization mode is energization mode [2], [4], or [6], reverse threshold setting unit 308 sets reverse threshold V_{RV_th} as follows. That is, when second switching time detection value E2_{SW} is greater than upper reverse threshold V_{RV_th1}, reverse threshold setting unit 308 sets second switching time detection value E2_{SW} as reverse threshold V_{RV_th}. On the other hand, when second switching time detection value E2_{SW} is equal to or greater than upper reverse threshold V_{RV_th1}, reverse threshold setting unit 308 sets upper reverse threshold V_{RV_th1} as reverse threshold V_{RV_th}.

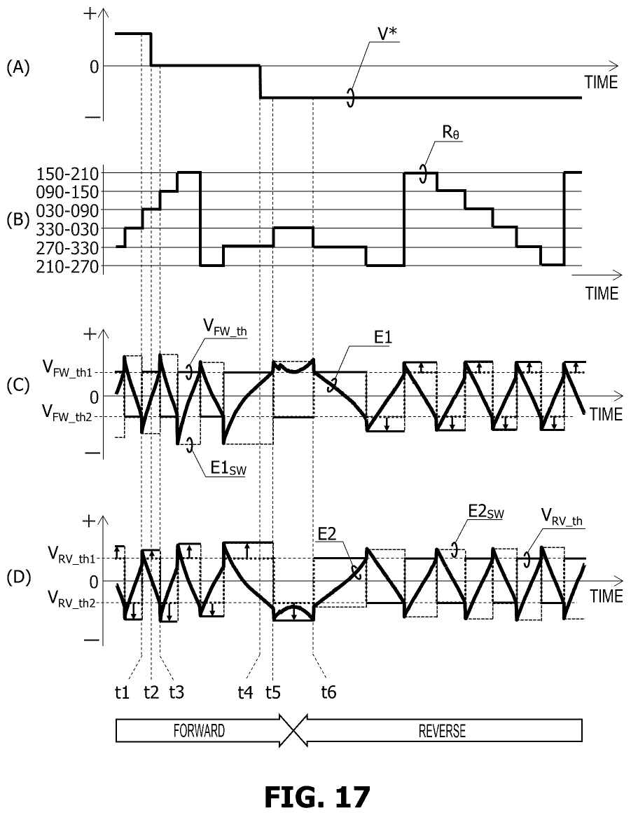

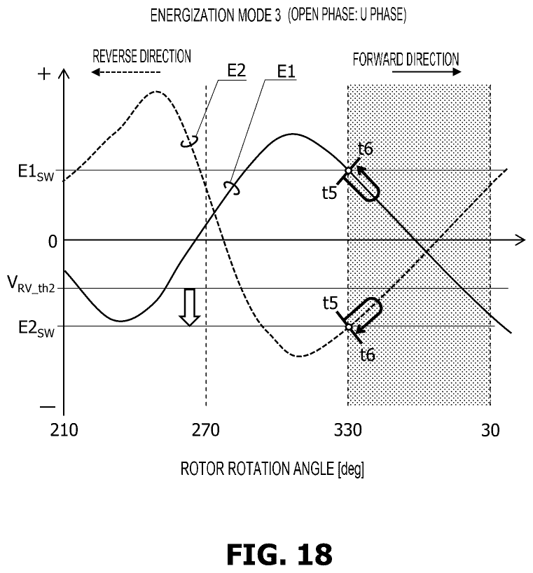

FIG. 17 schematically illustrates an improved operation example of electric motor 1 when motor control apparatus 3 executes low-speed sensorless control. In FIG. 17, (A) illustrates change of application voltage command value V* over time, (B) illustrates change of rotor rotation angle range R_{θ} detected by motor control apparatus 3 over time, (C) illustrates change of forward open-phase voltage E1 over time, and (D) illustrates change of reverse open-phase voltage E2 over time. FIG. 18 illustrates change of forward open-phase voltage E1 and reverse open-phase voltage E2 with respect to the rotor rotation angle between time t5 and time t6 in FIG. 17.

As illustrated in (A) of FIG. 17, application voltage command value V* is a positive value representing a forward drive command until time t2. Application voltage command value V* changes to zero representing a drive stop command at time t2, and changes to a negative value representing a reverse drive command at time t4.

Immediately before time t1, as illustrated in (B) of FIG. 17, motor control apparatus 3 has detected that rotor rotation angle range R_{θ} is the range from 330° to 30°, a pulse voltage is applied to electric motor 1 in energization mode [3], and the forward drive is executed (see FIGS. 3 and 6).

Assuming that the value of forward open-phase voltage E1 falls below lower forward threshold V_{FW_th2} at time t1 as illustrated in (C) of FIG. 17, motor control apparatus 3 determines that rotor rotation angle range R_{θ} has shifted from the range from 330° to 30° to the range from 30° to 90° as illustrated in (B) of FIG. 17, and switches the current energization mode from energization mode [3] to energization mode [4] (see FIG. 6). As a result, forward open-phase voltage E1 is calculated based on W-phase application voltage Vw during the application of the forward pulse, and monotonically increases from first switching time detection value E1_{SW} as illustrated in (C) of FIG. 17 (see FIGS. 3, 6, and 14). Because first switching time detection value E1_{SW} is less than upper forward threshold V_{FW_th1} that is set in advance as the forward initial threshold in energization mode [4], forward threshold setting unit 307 sets upper forward threshold V_{FW_th1} as forward threshold V_{FW_th}. On the other hand, reverse open-phase voltage E2 is calculated based on W-phase application voltage Vw during the application of the reverse pulse, and monotonically decreases from second switching time detection value E2_{SW} as illustrated in (D) of FIG. 17 (see FIGS. 4, 7, and 14). Because second switching time detection value E2_{SW} is greater than upper reverse threshold V_{RV_th1} that is set in advance as the reverse initial threshold in energization mode [4], reverse threshold setting unit 308 sets second switching time detection value E2_{SW} as reverse threshold V_{RV_th}.

When application voltage command value V* represents zero at time t2, the forward drive is stopped. Even after the forward drive is stopped, rotor 11 is continuously rotated in the forward direction by inertia, and the switching control of the energization mode is continuously executed in this drive stop state.

When the value of forward open-phase voltage E1 exceeds upper forward threshold V_{FW_th1} at time t3 as illustrated in (C) of FIG. 17, motor control apparatus 3 determines that rotor rotation angle range R_{θ} has shifted to the range from 90° to 150°, and switches the current energization mode from energization mode [4] to energization mode [5]. On the other hand, reverse open-phase voltage E2 monotonically decreases from second switching time detection value E2_{SW} due to the forward rotation of rotor 11, and does not exceed second switching time detection value E2_{SW}. Thus, switching of the energization mode to the reverse direction is not executed. Thereafter, as long as rotor 11 is continuously rotated in the forward direction by inertia, motor control apparatus 3 sequentially switches the current energization mode from [6], [1], [2] . . . in this order.

At time t4, as illustrated in (B) of FIG. 17, motor control apparatus 3 has already detected that rotor rotation angle range R_{θ} is the range from 270° to 330°, and a pulse voltage is applied to electric motor 1 in energization mode [2]. In energization mode [2], forward open-phase voltage E1 is calculated based on V-phase application voltage Vv during the application of the forward pulse, and reverse open-phase voltage E2 is calculated based on V-phase application voltage Vv during the application of the reverse pulse. In addition, forward threshold setting unit 307 sets upper forward threshold V_{FW_th1} as forward threshold V_{FW_th}, and reverse threshold setting unit 308 sets second switching time detection value E2_{SW} as reverse threshold V_{RV_th}. At this time t4, when application voltage command value V* changes to a negative value, the reverse drive is started (see FIG. 4). The present example assumes that at this point in time, rotor 11 is still rotating in the forward direction by inertia.

At time t5, when the value of forward open-phase voltage E1 exceeds upper forward threshold V_{FW_th1} by the forward rotation of rotor 11, motor control apparatus 3 determines that rotor rotation angle range R_{θ} is the range from 330° to 30°, and switches the current energization mode from energization mode [2] to energization mode [3]. On the other hand, reverse open-phase voltage E2 monotonically decreases from second switching time detection value E2_{SW} by the forward rotation of rotor 11, and does not exceed second switching time detection value E2_{SW}. Thus, switching of the energization mode to the reverse direction is not executed.

In energization mode [3], forward open-phase voltage E1 is calculated based on U-phase application voltage Vu during the application of the forward pulse. If rotor 11 continuously rotated in the forward direction, forward open-phase voltage E1 monotonically decreases from first switching time detection value E1_{SW} as illustrated in FIG. 18 (see FIGS. 3, 6, and 14). As illustrated in (C) of FIG. 17, because first switching time detection value E1_{SW} is greater than lower forward threshold V_{FW_th2} that is set in advance as the forward initial threshold in energization mode [3], forward threshold setting unit 307 sets lower forward threshold V_{FW_th2} as forward threshold V_{FW_th}. On the other hand, in energization mode [3], reverse open-phase voltage E2 is calculated based on U-phase application voltage Vu during the application of the reverse pulse. If rotor 11 is continuously rotated in the forward direction, reverse open-phase voltage E2 monotonically increases from second switching time detection value E2_{SW} as illustrated in FIG. 18 (see FIGS. 4, 7, and 14). As illustrated in (D) of FIG. 17 and FIG. 18, because second switching time detection value E2_{SW} is less than lower reverse threshold V_{RV_th2} that is set in advance as the reverse initial threshold in energization mode [3], reverse threshold setting unit 308 sets second switching time detection value E2_{SW} as reverse threshold V_{RV_th}.

After time t5, as illustrated in (D) of FIG. 17 and FIG. 18, when the rotation of rotor 11 is changed from the forward rotation to the reverse rotation by the start of the reverse drive (time t4), reverse open-phase voltage E2 is less than lower reverse threshold V_{RV_th2}. If lower reverse threshold V_{RV_th2} is set as reverse threshold V_{RV_th}, reverse open-phase voltage E2 cannot fall below lower reverse threshold V_{RV_th2}, and it is difficult for the current energization mode to switch from energization mode [3] to energization mode [2], as described above. However, in motor control apparatus 3, second switching time detection value E2_{SW} is set as reverse threshold V_{RV_th} at time t5. Thus, when rotor 11 starts to rotate in the reverse direction and when reverse open-phase voltage E2 starts to change in the reverse direction as illustrated in FIG. 18, reverse open-phase voltage E2 falls below second switching time detection value E2_{SW} at time t6 at which the rotor rotation angle reaches the energization switching angle of 330°.

At time t6, as illustrated in (D) of FIG. 17, when the value of reverse open-phase voltage E2 falls below second switching time detection value E2_{SW}, motor control apparatus 3 determines that rotor rotation angle range R_{θ} has shifted to the range from 270° to 330°, and switches the energization mode from energization mode [3] to energization mode [2]. On the other hand, because the rotation of rotor 11 has been changed from the forward rotation to the reverse rotation, forward open-phase voltage E1 does not decrease to lower forward threshold V_{FW_th2}, and therefore, switching of the energization mode to the forward direction is not executed.

Hereinafter, the main points of the above-described improved operation of electric motor 1 when motor control apparatus 3 executes low-speed sensorless control will be described in more detail.

In principle, forward threshold V_{FW_th} and reverse threshold V_{RV_th} are set as follows in motor control apparatus 3. That is, when the current energization mode is energization mode [2], [4], or [6], in principle, upper forward threshold V_{FW_th1}, which is the forward initial threshold, is set as forward threshold V_{FW_th}, and upper reverse threshold V_{RV_th1}, which is the reverse initial threshold, is set as reverse threshold V_{RV_th}. In addition, when the current energization mode is energization mode [1], [3], or [5], in principle, lower forward threshold V_{FW_th2}, which is the forward initial threshold, is set as forward threshold V_{FW_th}, and lower reverse threshold V_{RV_th2}, which is the reverse initial threshold, is set as reverse threshold V_{RV_th}.

However, when first switching time detection value E1_{SW} immediately after the current energization mode is switched to energization mode [1], [3], or [5] by the reverse rotation of rotor 11 is less than lower forward threshold V_{FW_th2}, forward threshold V_{FW_th} is set to first switching time detection value E1_{SW}. In addition, when first switching time detection value E1_{SW} immediately after the current energization mode is switched to energization mode [2], [4], or [6] by the reverse rotation of rotor 11 is greater than upper forward threshold V_{FW_th1}, forward threshold V_{FW_th} is set to first switching time detection value E1_{SW}. In this way, when the rotation of rotor 11 changes from the reverse rotation to the forward rotation, even if the value of forward open-phase voltage E1 is greater than upper forward threshold V_{FW_th1} or is less than lower forward threshold V_{FW_th2}, the energization mode can be successfully switched to the forward direction. This is because in response to the changing of the rotation of rotor 11 from the reverse rotation to the forward rotation, the value of forward open-phase voltage E1 returns to first switching time detection value E1_{SW} set as forward threshold V_{FW_th} and falls below or exceeds first switching time detection value E1_{SW}.

On the other hand, when second switching time detection value E2_{SW} immediately after the current energization mode is switched to energization mode [1], [3], or [5] by the forward rotation of rotor 11 is less than lower reverse threshold V_{RV_th2}, reverse threshold V_{RV_th} is set to second switching time detection value E2_{SW}. In addition, when second switching time detection value E2_{SW} immediately after the current energization mode is switched to energization mode [2], [4], or [6] by the forward rotation of rotor 11 is greater than upper reverse threshold V_{RV_th1}, reverse threshold V_{RV_th} is set to second switching time detection value E2_{SW}. In this way, when the rotation of rotor 11 changes from the forward rotation to the reverse rotation, even if the value of reverse open-phase voltage E2 is greater than upper reverse threshold V_{RV_th1} or is less than lower reverse threshold V_{RV_th2}, the energization mode can be successfully switched to the reverse direction. This is because in response to the changing of the rotation of rotor 11 from the forward rotation to the reverse rotation, the value of reverse open-phase voltage E2 returns to second switching time detection value E2_{SW} set as reverse threshold V_{RV_th} and falls below or exceeds second switching time detection value E2_{SW}.

Even when the rotation direction of rotor 11 is inverted, since motor control apparatus 3 as described above is able to accurately detect the timing at which the energization mode is switched to the inverted direction, the loss of synchronization of electric motor 1 can be reduced significantly. As a result, it is possible to prevent rotor 11 from rotating in the opposite direction that does not match a drive command (forward drive command or reverse drive command) received by motor control apparatus 3 or to prevent rotor 11 from stopping its rotation contrary to a drive command.

### First Modification

Next, a first modification of motor control apparatus 3 will be described. The present modification assumes a case in which there is a very short time between when the rotation of rotor 11 is changed from the reverse rotation to the forward rotation and when the value of forward open-phase voltage E1 returns to first switching time detection value E1_{SW} set as forward threshold V_{FW_th}. The present modification improves reliability in detecting the timing of the switching of the energization mode to the forward direction. In addition, the present modification assumes a case in which there is a very short time between when the rotation of rotor 11 is changed from the forward rotation to the reverse rotation and when the value of reverse open-phase voltage E2 returns to second switching time detection value E2_{SW} set as reverse threshold V_{RV_th}. The present modification improves reliability in detecting the timing of the switching of the energization mode to the reverse direction.

Specifically, when first switching time detection value E1_{SW} is set as forward threshold V_{FW_th}, motor control apparatus 3 corrects first switching time detection value E1_{SW} as follows. That is, motor control apparatus 3 sets, as forward threshold V_{FW_th}, a value obtained by adding offset value ΔEp (>0), which is a positive value, to first switching time detection value E1_{SW}, which is a positive value, or sets a value obtained by adding offset value ΔEn (<0), which is a negative value, to first switching time detection value E1_{SW}, which is a negative value. When setting second switching time detection value E2_{SW} as reverse threshold V_{RV_th}, motor control apparatus 3 corrects second switching time detection value E2_{SW} as follows. That is, motor control apparatus 3 sets, as reverse threshold V_{RV_th}, a value obtained by adding offset value ΔEp (>0), which is a positive value, to second switching time detection value E2_{SW}, which is a positive value, or sets a value obtained by adding offset value ΔEn (<0), which is a negative value, to second switching time detection value E2_{SW}, which is a negative value. In short, the predetermined offset value ΔEp or ΔEn is added to a corresponding one of first switching time detection value E1_{SW} and second switching time detection value E2_{SW}, so as to increase the absolute value of each of forward threshold V_{FW_th} and reverse threshold V_{RV_th}.

According to the first modification, by correcting first switching time detection value E1_{SW} as described above, it is possible to extend the time between when the rotation of rotor 11 is changed from the reverse rotation to the forward rotation and when the value of forward open-phase voltage E1 returns to corrected first switching time detection value E1_{SW}, compared with a case in which first switching time detection value E1_{SW} is not corrected. As a result, it is possible to prevent electric motor 1 from undergoing the loss of synchronization that occurs due to the value of forward open-phase voltage E1 having already fallen below or exceeded first switching time detection value E1_{SW} when the value of forward open-phase voltage E1 and first switching time detection value E1_{SW} are compared with each other.

In addition, according to the first modification, by correcting second switching time detection value E2_{SW} as described above, it is possible to extend the time between when the rotation of rotor 11 is changed from the forward rotation to the reverse rotation and when the value of reverse open-phase voltage E2 returns to corrected second switching time detection value E2_{SW}, compared with a case in which second switching time detection value E2_{SW} is not corrected. As a result, it is possible to prevent electric motor 1 from undergoing the loss of synchronization that occurs due to the value of reverse open-phase voltage E2 having already fallen below or exceeded second switching time detection value E2_{SW} when the value of reverse open-phase voltage E2 and second switching time detection value E2_{SW} are compared with each other.

### Second Modification

Next, a second modification of motor control apparatus 3 will be described. The present modification assumes a case in which first switching time detection value E1_{SW} and second switching time detection value E2_{SW} indicate abnormal values due to electrical noise, etc. The present modification limits the ranges within which forward threshold V_{FW_th} and reverse threshold V_{RV_th} are settable.

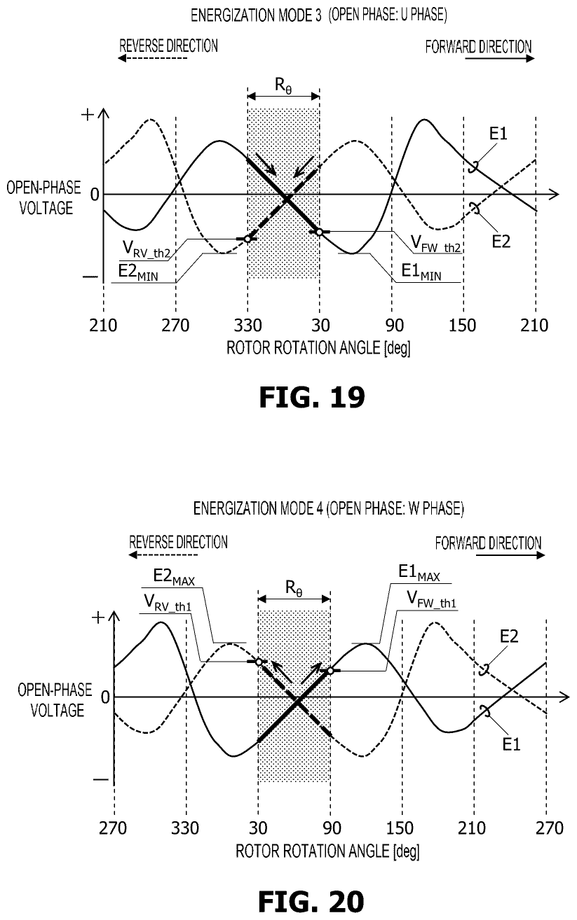

Hereinafter, lower limit values of forward threshold V_{FW_th} and reverse threshold V_{RV_th} will be described with reference to FIG. 19. FIG. 19 illustrates an example of change of forward open-phase voltage E1 and an example of change of reverse open-phase voltage E2 in energization mode [3] with respect to the rotor rotation angle.

As illustrated in FIG. 19, when rotor rotation angle range R_{θ} is the range from 330° to 30° corresponding to energization mode [3], forward open-phase voltage E1 falls within a monotonically decreasing section in the forward direction, and reverse open-phase voltage E2 falls within a monotonically decreasing section in the reverse direction. Unless the energization mode is switched, forward open-phase voltage E1 continues to monotonically decrease first and monotonically increases next in the range from 30° to 90°. Hereinafter, the voltage value at which forward open-phase voltage E1 changes from the monotonic decrease to the monotonic increase will be referred to as “forward switching limit value E1_{MIN}”. On the other hand, unless the current energization mode is switched, reverse open-phase voltage E2 continues to monotonically decrease first and monotonically increases next in the range from 270° to 330°. Hereinafter, the voltage value at which reverse open-phase voltage E2 changes from the monotonic decrease to the monotonic increase will be referred to as “reverse switching limit value E2_{MIN}”. If forward threshold V_{FW_th} is set to a value less than forward switching limit value E1_{MIN}, even if rotor 11 is rotated in the forward direction to the range from 30° to 90°, the value of forward open-phase voltage E1 may not fall below forward threshold V_{FW_th}. In addition, if reverse threshold V_{RV_th} is set to a value less than reverse switching limit value E2_{MIN}, even if rotor 11 is rotated in the reverse direction to the range from 270° to 330°, the value of reverse open-phase voltage E2 may not fall below reverse threshold V_{RV_th}.

Thus, motor control apparatus 3 sets the lower limit value of forward threshold V_{FW_th} set by using first switching time detection value E1_{SW} instead of lower forward threshold V_{FW_th2} in a predetermined range that is less than lower forward threshold V_{FW_th2} and that is equal to or greater than forward switching limit value E1_{MIN}. In addition, motor control apparatus 3 sets the lower limit value of reverse threshold V_{RV_th} set by using second switching time detection value E2_{SW} instead of lower reverse threshold V_{RV_th2} in a predetermined range that is less than lower reverse threshold V_{RV_th2} and that is equal to or greater than reverse switching limit value E2_{MIN}. In energization modes [1] and [5] in which forward open-phase voltage E1 monotonically decreases in the forward direction and reverse open-phase voltage E2 monotonically decreases in the reverse direction, the lower limit values of their respective forward threshold V_{FW_th} and reverse threshold V_{RV_th} are set as in energization mode [3]. As a result, when forward threshold V_{FW_th} set by using first switching time detection value E1_{SW} is less than its lower limit value, forward threshold V_{FW_th} is modified to the lower limit value. In addition, when reverse threshold V_{RV_th} set by using second switching time detection value E2_{SW} is less than its lower limit value, reverse threshold V_{RV_th} is modified to the lower limit value.

Next, upper limit values of forward threshold V_{FW_th} and reverse threshold V_{RV_th} will be described with reference to FIG. 20. FIG. 20 illustrates an example of change of forward open-phase voltage E1 and an example of change of reverse open-phase voltage E2 in energization mode [4] with respect to the rotor rotation angle.

As illustrated in FIG. 20, when rotor rotation angle range R_{θ} is the range from 30° to 90° corresponding to energization mode [4], forward open-phase voltage E1 falls within a monotonically increasing section in the forward direction, and reverse open-phase voltage E2 falls within a monotonically increasing section in the reverse direction. Unless the energization mode is switched, forward open-phase voltage E1 continues to monotonically increase first and monotonically decreases next in the range from 90° to 150°. Hereinafter, the voltage value at which forward open-phase voltage E1 changes from the monotonic increase to the monotonic decrease will be referred to as “forward switching limit value E1_{MAX}”. On the other hand, unless the current energization mode is switched, reverse open-phase voltage E2 continues to monotonically increase first and monotonically decreases next in the range from 330° to 30°. Hereinafter, the voltage value at which reverse open-phase voltage E2 changes from the monotonic increase to the monotonic decrease will be referred to as “reverse switching limit value E2_{MAX}”. If forward threshold V_{FW_th} is set to a value greater than forward switching limit value E1_{MAX}, even if rotor 11 is rotated in the forward direction to the range from 90° to 150°, the value of forward open-phase voltage E1 may not exceed forward threshold V_{FW_th}. In addition, if reverse threshold V_{RV_th} is set to a value greater than reverse switching limit value E2_{MAX}, even if rotor 11 is rotated in the reverse direction to the range from 330° to 30°, reverse open-phase voltage E2 may not exceed reverse threshold V_{RV_th}.

Thus, motor control apparatus 3 sets the lower limit value of forward threshold V_{FW_th} set by using first switching time detection value E1_{SW} instead of upper forward threshold V_{FW_th1} in a predetermined range that is equal to or less than forward switching limit value E1_{MAX} and that is greater than upper forward threshold V_{FW_th1}. In addition, motor control apparatus 3 sets the upper limit value of reverse threshold V_{RV_th} set by using second switching time detection value E2_{SW} instead of upper reverse threshold V_{RV_th1} in a predetermined range that is equal to or less than reverse switching limit value E2_{MAX} and that is greater than upper reverse threshold V_{RV_th1}. In energization modes [2] and [6] in which forward open-phase voltage E1 monotonically increases in the forward direction and reverse open-phase voltage E2 monotonically increases in the reverse direction, the upper limit values of their respective forward threshold V_{FW_th} and reverse threshold V_{RV_th} are set as in energization mode [4]. As a result, when forward threshold V_{FW_th} set by using first switching time detection value E1_{SW} is greater than its upper limit value, forward threshold V_{FW_th} is modified to the upper limit value. In addition, when reverse threshold V_{RV_th} set by using second switching time detection value E2_{SW} is greater than its upper limit value, reverse threshold V_{RV_th} is modified to the upper limit value.

According to the second modification, even in a case in which first switching time detection value E1_{SW} and second switching time detection value E2_{SW} indicate abnormal values due to electrical noise, etc., the lower limit value and the upper limit value of each of forward threshold V_{FW_th} and reverse threshold V_{RV_th} are set within their respective predetermined ranges as described above. Thus, the probability of the loss of synchronization of electric motor 1 can be reduced further.

### Third Modification

Next, a third modification of motor control apparatus 3 will be described. The present modification reduces the processing load of motor control apparatus 3, by focusing on the loss of synchronization of electric motor 1 described with reference to FIGS. 21 and 22 occurring due to the inversion of the rotation direction of rotor 11.

Specifically, when a rotor rotation speed N is less than a predetermined value Nc, motor control apparatus 3 sets the forward initial thresholds or first switching time detection value E1_{SW} as forward threshold V_{FW_th}. When rotor rotation speed N is less than predetermined value Nc, motor control apparatus 3 sets the reverse initial thresholds or second switching time detection value E2_{SW} as reverse threshold V_{RV_th}. In other words, when rotor rotation speed N is equal to or greater than predetermined value Nc, motor control apparatus 3 sets, between upper forward threshold V_{FW_th1} and lower forward threshold V_{FW_th2}, the value based on the energization mode as forward threshold V_{FW_th}, without using first switching time detection value E1_{SW}. In addition, when rotor rotation speed N is equal to or greater than predetermined value Nc, motor control apparatus 3 sets, between upper reverse threshold V_{RV_th1} and lower reverse threshold V_{RV_th2}, the value based on the energization mode as reverse threshold V_{RV_th}, without using second switching time detection value E2_{SW}. Rotor rotation speed N can be acquired based on the change rate of energization mode signal S_{MODE} (for example, based on the reciprocal of the energization mode switching interval).

According to the third modification, in a situation in which the probability that the loss of synchronization of electric motor 1 will occur is low, motor control apparatus 3 sets forward threshold V_{FW_th} without using first switching time detection value E1_{SW}, and sets reverse threshold V_{RV_th} without second switching time detection value E2_{SW}. Thus, the third modification can reduce the processing load of motor control apparatus 3 associated with the setting of forward threshold V_{FW_th} and reverse threshold V_{RV_th}.

### Fourth Modification

Next, a fourth modification of motor control apparatus 3 will be described. As in the third modification, the present modification reduces the processing load of motor control apparatus 3, by focusing on the loss of synchronization of electric motor 1 described with reference to FIGS. 21 and 22 occurring due to the inversion of the rotation direction of rotor 11.

Specifically, motor control apparatus 3 begins the setting of forward threshold V_{FW_th} by using first switching time detection value E1_{SW} or begins the setting of reverse threshold V_{RV_th} by using second switching time detection value E2_{SW} after beginning the drive for inverting the rotation direction of rotor 11. For example, when the sign of application voltage command value V* is inverted, in other words, when the comparative relationship between the pulse width of the individual forward pulse and the pulse width of the individual reverse pulse is inverted, it is determined that the drive for inverting the rotation direction of rotor 11 has started. There is a case in which while rotor 11 is rotating in one direction by inertia, the drive for rotating rotor 11 in the other direction starts. In this case, it is also determined that the drive for inverting the rotation direction of rotor 11 has started. This is because even when application voltage command value V* is zero, rotor 11 may still be rotating by inertia due to effects of the rotation drive based on previous application voltage command value V* or effects of external forces. Thus, if the rotation direction of rotor 11 when application voltage command value V* is zero can be detected, when application voltage command value V* changes from zero to a positive value or a negative value, it is possible to determine that the drive for inverting the rotation direction rotor 11 has started. In addition, if the rotation direction of rotor 11 when the pulse width of the individual forward pulse and the pulse width of the individual reverse pulse are equal to each other can be detected, when the pulse width of the individual forward pulse and the pulse width of the individual reverse pulse become different from each other, it is possible to determine that the drive for inverting the rotation direction of rotor 11 has started. The rotation direction of rotor 11 can be detected based on change in energization mode signal S_{MODE}.

The setting of forward threshold V_{FW_th} by using first switching time detection value E1_{SW} or the setting of reverse threshold V_{RV_th} by using second switching time detection value E2_{SW} ends when a predetermined time Tc elapses after the start of the drive for inverting the rotation direction of rotor 11. Alternatively, the setting of forward threshold V_{FW_th} by using first switching time detection value E1_{SW} or the setting of reverse threshold V_{RV_th} by using second switching time detection value E2_{SW} ends when the number of times of switching the energization mode after the start of the drive for inverting the rotation direction of rotor 11 reaches a predetermined value Sc. Alternatively, the setting of forward threshold V_{FW_th} by using first switching time detection value E1_{SW} or the setting of reverse threshold V_{RV_th} by using second switching time detection value E2_{SW} ends when rotor rotation speed N reaches predetermined value Nc or greater as described above.

The fourth modification can reduce the processing load of motor control apparatus 3 associated with the setting of forward threshold V_{FW_th} and reverse threshold V_{RV_th} in a situation in which the probability that the loss of synchronization of electric motor 1 will occur is low.

### Fifth Modification

Next, a fifth modification of motor control apparatus 3 will be described. As in the third modification, the present modification reduces the processing load of motor control apparatus 3, by focusing on the loss of synchronization of electric motor 1 described with reference to FIGS. 21 and 22 occurring due to the inversion of the rotation direction of rotor 11.

As described above, the loss of synchronization of electric motor 1 occurs because, in one mode, reverse open-phase voltage E2 is greater than upper reverse threshold V_{RV_th1} or less than lower reverse threshold V_{RV_th2} when the rotation of rotor 11 changes from the forward rotation to the reverse rotation. In addition, as described above, the loss of synchronization of electric motor 1 occurs because, in another mode, forward open-phase voltage E1 is greater than upper forward threshold V_{FW_th1} or less than lower forward threshold V_{FW_th2} when the rotation of rotor 11 changes from the reverse rotation to the forward rotation. Thus, motor control apparatus 3 may continually set reverse threshold V_{RV_th} by using second switching time detection value E2_{SW} only when rotor 11 is rotating in the forward direction. On the other hand, motor control apparatus 3 may continually set forward threshold V_{FW_th} by using first switching time detection value E1_{SW} only when rotor 11 is rotating in the reverse direction.

The fifth modification can reduce the processing load of motor control apparatus 3 associated with the setting of forward threshold V_{FW_th} and reverse threshold V_{RV_th} in a situation in which the probability that the loss of synchronization of electric motor 1 will occur is low.

### Sixth Modification

Next, a sixth modification of motor control apparatus 3 will be described. The present modification shortens the time between when the rotation direction of rotor 11 is inverted and when the energization mode is switched.

As described above, when first switching time detection value E1_{SW} is greater than upper forward threshold V_{FW_th1}, first switching time detection value E1_{SW} is set as forward threshold V_{FW_th}. Instead, when first switching time detection value E1_{SW} is greater than upper forward threshold V_{FW_th1}, both of first switching time detection value E1_{SW} and upper forward threshold V_{FW_th1} are set as forward threshold V_{FW_th}. In this way, if forward open-phase voltage E1 is equal to or less than upper forward threshold V_{FW_th1} when the rotation of rotor 11 changes from the reverse rotation to the forward rotation, forward open-phase voltage E1 can exceed upper forward threshold V_{FW_th1} before first switching time detection value E1_{SW} as rotor 11 is rotated in the forward direction. Thus, because the time needed for forward open-phase voltage E1 to exceed upper forward threshold V_{FW_th1} is less than the time needed for forward open-phase voltage E1 to exceed first switching time detection value E1_{SW}, the energization mode can be quickly switched. If forward open-phase voltage E1 is greater than upper forward threshold V_{FW_th1} when the rotation of rotor 11 changes from the reverse rotation to the forward rotation, as described above, forward open-phase voltage E1 exceeds first switching time detection value E1_{SW} as rotor 11 is rotated in the forward direction, and the energization mode is successfully switched to the forward direction. Similarly, when first switching time detection value E1_{SW} is less than lower forward threshold V_{FW_th2}, both of first switching time detection value E1_{SW} and lower forward threshold V_{FW_th2} are set as forward threshold V_{FW_th}. In this way, if forward open-phase voltage E1 is equal to or greater than lower forward threshold V_{FW_th2} when the rotation of rotor 11 changes from the reverse rotation to the forward rotation, forward open-phase voltage E1 can fall below lower forward threshold V_{FW_th2} before first switching time detection value E1_{SW}, and the energization mode can be quickly switched.

As described above, when second switching time detection value E2_{SW} is greater than upper reverse threshold V_{RV_th1}, second switching time detection value E2_{SW} is set as reverse threshold V_{RV_th}. Instead, when second switching time detection value E2_{SW} is greater than upper reverse threshold V_{RV_th1}, both second switching time detection value E2_{SW} and upper reverse threshold V_{RV_th1} are set as reverse threshold V_{RV_th}. In this way, if reverse open-phase voltage E2 is equal to or less than upper reverse threshold V_{RV_th1} when the rotation of rotor 11 changes from the forward rotation to the reverse rotation, reverse open-phase voltage E2 can exceed upper reverse threshold V_{RV_th1} before second switching time detection value E2_{SW} as rotor 11 is rotated in the reverse direction. Thus, because the time needed for reverse open-phase voltage E2 to exceed upper reverse threshold V_{RV_th1} is less than the time needed for reverse open-phase voltage E2 to exceed second switching time detection value E2_{SW}, the energization mode can be quickly switched. If reverse open-phase voltage E2 is greater than upper reverse threshold V_{RV_th1} when the rotation of rotor 11 changes from the forward rotation to the reverse rotation, as described above, reverse open-phase voltage E2 exceeds second switching time detection value E2_{SW} as rotor 11 is rotated in the reverse direction, and the energization mode is successfully switched to the reverse direction. Similarly, when second switching time detection value E2_{SW} is less than lower reverse threshold V_{RV_th2}, both second switching time detection value E2_{SW} and lower reverse threshold V_{RV_th2} are set as reverse threshold V_{RV_th}. In this way, if reverse open-phase voltage E2 is equal to or greater than lower reverse threshold V_{RV_th2} when the rotation of rotor 11 changes from the forward rotation to the reverse rotation, reverse open-phase voltage E2 can fall below lower reverse threshold V_{RV_th2} before second switching time detection value E2_{SW} as rotor 11 is rotated in the reverse direction, and the energization mode can be quickly switched.

According to the sixth modification, when the rotation direction of rotor 11 is inverted, the time between when the rotation direction of rotor 11 is inverted and when the energization mode is switched can be shortened.

Although the present invention has thus been described in detail with reference to a preferred example and its modifications, it will be apparent to those skilled in the art that various kinds of modification modes are possible, based on the technical concepts and teachings of the present invention.

As the initial forward thresholds, the same upper forward threshold V_{FW_th1} is set in energization modes [2], [4], and [6], and the same lower forward threshold V_{FW_th2} is set in energization modes [1], [3], and [5]. However, upper forward threshold V_{FW_th1} and lower forward threshold V_{FW_th2} may each be set to a different value in advance per energization mode. Similarly, as the initial reverse thresholds, the same upper reverse threshold V_{RV_th1} is set in energization modes [2], [4], and [6], and the same lower reverse threshold V_{RV_th2} is set in energization modes [1], [3], and [5]. However, upper reverse threshold V_{RV_th1} and lower reverse threshold V_{RV_th2} may each be set to a different value in advance per energization mode.

The expression “when the value of forward open-phase voltage E1 falls below a forward threshold V_{FW_th}” may include the meaning of when the value of forward open-phase voltage E1 decreases from a range greater than forward threshold V_{FW_th} to a range equal to or less than forward threshold V_{FW_th}. Alternatively, the expression may mean only when the value of forward open-phase voltage E1 decreases from a range greater than forward threshold V_{FW_th} to a range equal to or less than forward threshold V_{FW_th}. In addition, the expression “when the value of forward open-phase voltage E1 exceeds forward threshold V_{FW_th}” may include the meaning of when the value of forward open-phase voltage E1 increases from a range less than forward threshold V_{FW_th} to a range equal to or greater than forward threshold V_{FW_th}. Alternatively, the expression may mean only when the value of forward open-phase voltage E1 increases from a range less than forward threshold V_{FW_th} to a range equal to or greater than forward threshold V_{FW_th}. The same applies to the expressions “when reverse open-phase voltage E2 falls below a reverse threshold V_{RV_th}” and “when reverse open-phase voltage E2 exceeds reverse threshold V_{RV_th}”.

The individual technical concepts described in the above-described example and modifications based thereon can be appropriately combined and used, as long as there is no conflict. For example, two or more of the first to sixth modifications may be appropriately combined and used, as long as there is no conflict.

### REFERENCE SYMBOL LIST

1 Electric motor
2 Drive circuit
3 Motor control apparatus
11 Rotor
12u, 12v, 12w Three-phase coil
301 Voltage command adjustment unit
302 PWM signal generation unit
303 Gate signal generation unit
304 Energization mode determination unit
306 Open-phase voltage detection unit
307 Forward threshold setting unit
308 Reverse threshold setting unit
309, 310 Comparison unit
[1], [2], [3], [4], [5], [6] Energization mode
E1 Forward open-phase voltage (first open-phase voltage)
E2 Reverse open-phase voltage (second open-phase voltage)
E1_{SW} First switching time detection value
E2_{SW} Second switching time detection value
E1_{MIN}, E1_{MAX} Forward switching limit value
E2_{MIN}, E2_{MAX} Reverse switching limit value
ΔEp, ΔEn Offset value
N Rotor rotation speed
Nc Predetermined value
Sc Predetermined value
Tc Predetermined time
Vuv, Vvw, Vwu Three-phase line-to-line voltage (pulse voltage)
V_{FW_th} Forward threshold (first threshold)
V_{RV_th} Reverse threshold (second threshold)
V_{FW_th1} Upper forward threshold (first initial threshold)
V_{FW_th2} Lower forward threshold (first initial threshold)
V_{RV_th1} Upper reverse threshold (second initial threshold)
V_{RV_th2} Lower reverse threshold (second initial threshold)

1. A motor control apparatus that rotates a rotor of an electric motor by sequentially switching an energization mode that determines two-phase coils to which a pulse voltage is applied, among three-phase coils of the electric motor, the motor control apparatus comprising a computer,
wherein the computer is configured to
output a control signal to a drive circuit that drives the electric motor such that the pulse voltage alternately generates a first pulse that rotates the rotor in one direction and a second pulse that has a polarity opposite to a polarity of the first pulse and that rotates the rotor in a direction opposite to the one direction, and control rotation drive in the one direction or the opposite direction by inverting a comparative relationship between an application time of the first pulse and an application time of the second pulse,
detect a first open-phase voltage induced in an open phase when the first pulse is applied, and detect a second open-phase voltage induced in an open phase when the second pulse is applied,
set, per energization mode, a first threshold that defines a value of the first open-phase voltage when the energization mode is switched to the one direction, and a second threshold that defines a value of the second open-phase voltage when the energization mode is switched to the opposite direction, and
switch the energization mode to the one direction or the opposite direction, based on a result of comparison between a value of the first open-phase voltage and the first threshold and based on a result of comparison between a value of the second open-phase voltage and the second threshold,
wherein when the energization mode is switched to the opposite direction, the computer sets, as a threshold setting process, the first threshold based on a first switching time detection value, which is a value of the first open-phase voltage immediately after the switching of the energization mode, and based on a first initial threshold that is set in advance per energization mode, and
wherein when the energization mode is switched to the one direction, the computer sets, as the threshold setting process, the second threshold based on a second switching time detection value, which is a value of the second open-phase voltage immediately after the switching of the energization mode, and based on a second initial threshold that is set in advance per energization mode.

2. The motor control apparatus according to claim 1,
wherein, per energization mode, the first initial threshold is set based on a first upper threshold or a first lower threshold that is less than the first upper threshold,
wherein, per energization mode, the second initial threshold is set based on a second upper threshold or a second lower threshold that is less than the second upper threshold,
wherein when the energization mode is switched to the opposite direction, if the first switching time detection value is greater than the first upper threshold or if the first switching time detection value is less than the first lower threshold, the first threshold is set by using the first switching time detection value, and
wherein when the energization mode is switched to the one direction, if the second switching time detection value is greater than the second upper threshold or if the second switching time detection value is less than the second lower threshold, the second threshold is set by using the second switching time detection value.

3. The motor control apparatus according to claim 2,
wherein when the energization mode is switched to the opposite direction, the first threshold is set by adding a positive offset value to the first switching time detection value that is greater than the first upper threshold or by adding a negative offset value to the first switching time detection value that is less than the first lower threshold, and
wherein when the energization mode is switched to the one direction, the second threshold is set by adding a positive offset value to the second switching time detection value that is greater than the second upper threshold or by adding a negative offset value to the second switching time detection value that is less than the second lower threshold.

4. The motor control apparatus according to claim 2,
wherein an upper limit is set in advance for the first threshold that is set based on the first switching time detection value that is greater than the first upper threshold and for the second threshold that is set based on the second switching time detection value that is greater than the second upper threshold, and
wherein a lower limit is set in advance for the first threshold that is set based on the first switching time detection value that is less than the first lower threshold and for the second threshold that is set based on the second switching time detection value that is less than the second lower threshold.

5. The motor control apparatus according to claim 1, wherein the threshold setting process is executed when an absolute value of a rotation speed of the rotor is less than a predetermined value.

6. The motor control apparatus according to claim 1, wherein the threshold setting process is executed until a predetermined time elapses after drive for inverting the rotation direction of the rotor is started or until the number of times of switching the energization mode reaches a predetermined value after drive for inverting the rotation direction of the rotor is started.

7. The motor control apparatus according to claim 1, wherein the computer continually sets the first threshold based on the first switching time detection value and the first initial threshold while the rotor is rotating in the opposite direction, and continually sets the second threshold based on the second switching time detection value and the second initial threshold while the rotor is rotating in the one direction.

8. The motor control apparatus according to claim 1,
wherein, per energization mode, the first initial threshold is set based on a first upper threshold or a first lower threshold that is less than the first upper threshold,
wherein, per energization mode, the second initial threshold is set based on a second upper threshold or a second lower threshold that is less than the second upper threshold,
wherein when the energization mode is switched to the opposite direction, if the first switching time detection value is greater than the first upper threshold, the first upper threshold and the first switching time detection value are set as the first threshold,
wherein when the energization mode is switched to the opposite direction, if the first switching time detection value is less than the first lower threshold, the first lower threshold and the first switching time detection value are set as the first threshold,
wherein when the energization mode is switched to the one direction, if the second switching time detection value is greater than the second upper threshold, the second upper threshold and the second switching time detection value are set as the second threshold, and
wherein when the energization mode is switched to the one direction, if the second switching time detection value is less than the second lower threshold, the second lower threshold and the second switching time detection value are set as the second threshold.

9. A motor control method for rotating a rotor of an electric motor by sequentially switching an energization mode that determines two-phase coils to which a pulse voltage is applied, among three-phase coils of the electric motor, the motor control method comprising:
outputting, by a computer, a control signal to a drive circuit that drives the electric motor such that the pulse voltage alternately generates a first pulse that rotates the rotor in one direction and a second pulse that has a polarity opposite to a polarity of the first pulse and that rotates the rotor in a direction opposite to the one direction;
controlling, by the computer, rotation drive in the one direction or the opposite direction by inverting a comparative relationship between an application time of the first pulse and an application time of the second pulse;
detecting, by the computer, a first open-phase voltage induced in an open phase when the first pulse is applied, and detecting a second open-phase voltage induced in an open phase when the second pulse is applied;
setting, by the computer, per energization mode, a first threshold that defines a value of the first open-phase voltage when the energization mode is switched to the one direction, and a second threshold that defines a value of the second open-phase voltage when the energization mode is switched to the opposite direction; and
switching, by the computer, the energization mode to the one direction or the opposite direction, based on a result of comparison between a value of the first open-phase voltage and the first threshold and based on a result of comparison between a value of the second open-phase voltage and the second threshold,
wherein when the energization mode is switched to the opposite direction, the computer sets the first threshold based on a first switching time detection value, which is a value of the first open-phase voltage immediately after the switching of the energization mode, and based on a first initial threshold that is set in advance per energization mode, and
wherein when the energization mode is switched to the one direction, the computer sets the second threshold based on a second switching time detection value, which is a value of the second open-phase voltage immediately after the switching of the energization mode, and based on a second initial threshold that is set in advance per energization mode.
